(19) United States
(12) Patent Application Publication
(10) Pub. No.: US 2021/0014301 A1
(43) Pub. Date: Jan. 14, 2021

(54) METHODS AND APPARATUS TO SELECT A LOCATION OF EXECUTION OF A COMPUTATION

(71) Applicant: Intel Corporation, Santa Clara, CA (US)

(72) Inventors: Kshitij Doshi, Tempe, AZ (US); Francesc Guim Bernat, Barcelona (ES); Ned Smith, Beaverton, OR (US); Timothy Verrall, Pleasant Hill, CA (US); Uzair Qureshi, Chandler, AZ (US)

(21) Appl. No.: 17/033,120

(22) Filed: Sep. 25, 2020

(51) Int. Cl. H04L 29/08

(52) U.S. Cl. CPC H04L 67/10

(57) ABSTRACT

Methods, apparatus, systems and articles of manufacture to select a location of execution of a computation are disclosed. An example apparatus includes a cache digest interface to identify a node capable of performing a computation. A compute plan solver is to obtain a cost estimate of performing the computation from the node. Privacy weighting circuitry is to apply a privacy weighting value to the cost estimate to determine a weighted cost estimate. The compute plan solver is to select the node for performance of the computation based on the weighted cost estimate. A plan executor is to transmit a request for the selected node to perform the computation.

### FIELD OF THE DISCLOSURE

This disclosure relates generally to edge computing, and, more particularly, to methods and apparatus to select a location of execution of a computation.

### BACKGROUND

In recent years, compute resources residing at network edges are expanding rapidly due to a need to support the rapid proliferation of devices that makeup the Internet of Things. The pooling of such resources is typically performed at the cloud level of the Internet but can also be performed at the edge level of the Internet.

### BRIEF DESCRIPTION OF THE DRAWINGS

FIG. 1 illustrates an overview of an edge cloud configuration for edge computing.

FIG. 2 illustrates operational layers among endpoints, an edge cloud, and cloud computing environments.

FIG. 3 illustrates a block diagram of an example environment for networking and services in an edge computing system.

FIG. 4 illustrates deployment of a virtual edge configuration in an edge computing system operated among multiple edge nodes and multiple tenants.

FIG. 5 illustrates various compute arrangements deploying containers in an edge computing system.

FIG. 6 illustrates an example compute and communication use case involving mobile access to applications in an example edge computing system.

FIG. 17 is a block diagram illustrating example provider nodes communicating with a consumer node in the edge cloud of FIG. 1.

FIG. 8 is a block diagram illustrating an example implementation of the example provider node of FIG. 7.

FIG. 9 is a block diagram illustrating an example implementation of the example consumer node of FIG. 7.

FIG. 10 is a flowchart representative of example machine readable instructions that may be executed to implement the example consumer node of FIGS. 7 and/or 9.

FIG. 11 is a flowchart representative of example machine readable instructions that may be executed to implement the example provider node of FIGS. 7 and/or 8 to provide digest information to an example consumer node.

FIG. 12 is a flowchart representative of example machine readable instructions that may be executed to implement the example provider node of FIGS. 7 and/or 8 to provide a cost estimate of performing a computation.

FIG. 13 is a flowchart representative of example machine readable instructions that may be executed to implement the example provider node of FIGS. 7 and/or 8 to generate a meta model for use by other provider nodes.

FIG. 14 is a flowchart representative of example machine readable instructions that may be executed to implement the example provider node of FIGS. 7 and/or 8 to execute an operation requested by a consumer node.

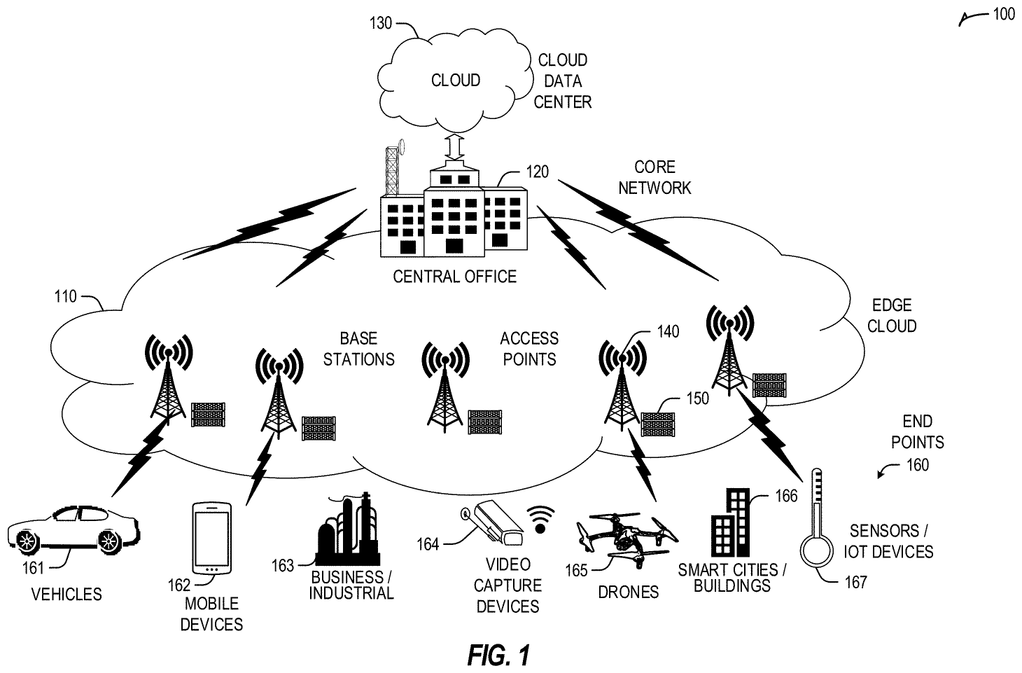

FIG. 15 is a block diagram of an example implementation of an example compute node that may be deployed in one of the edge computing systems illustrated in FIGS. 1-4 and/or 6.

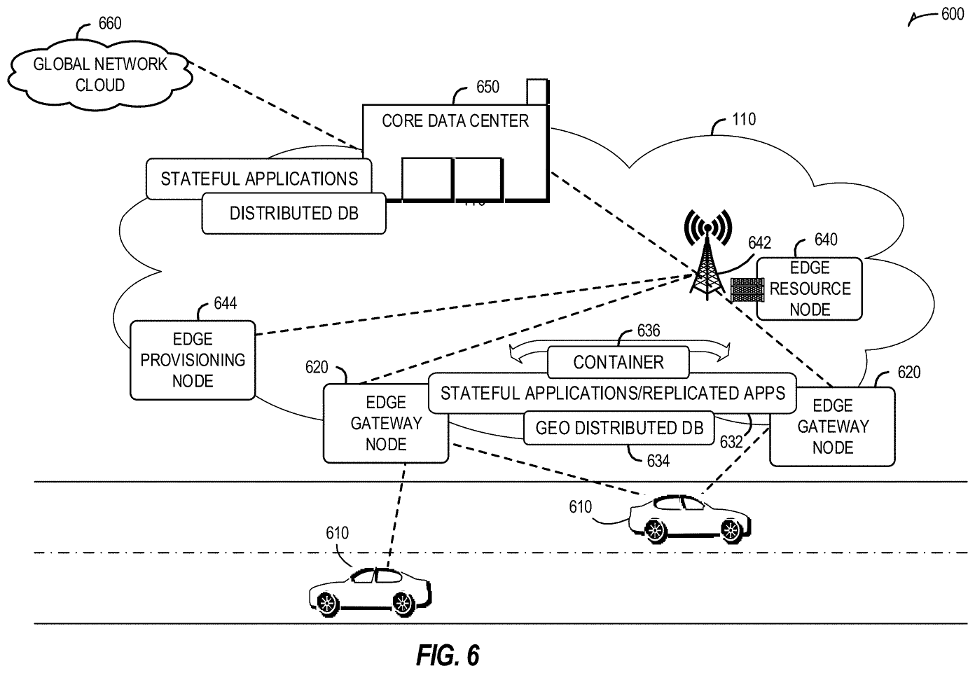

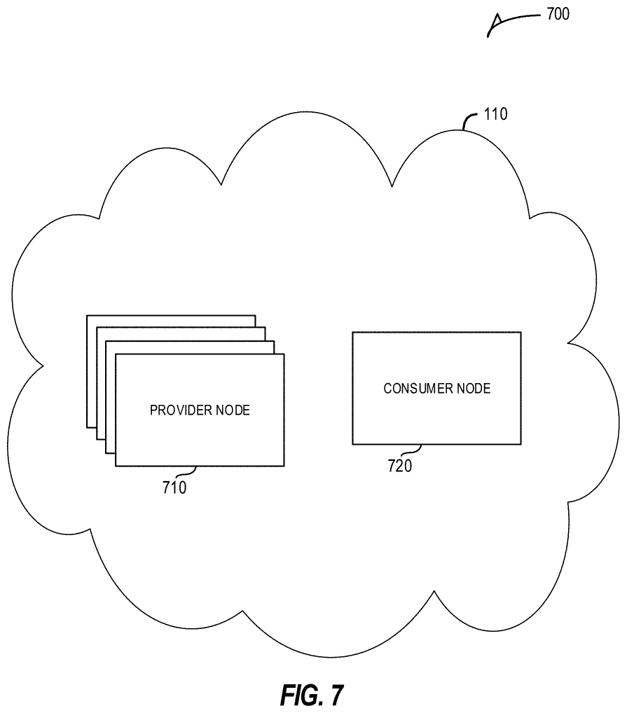

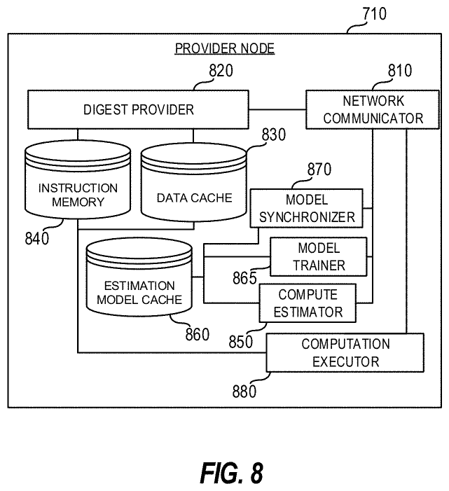

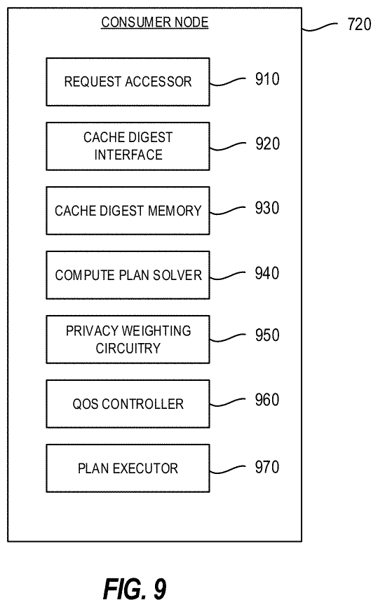

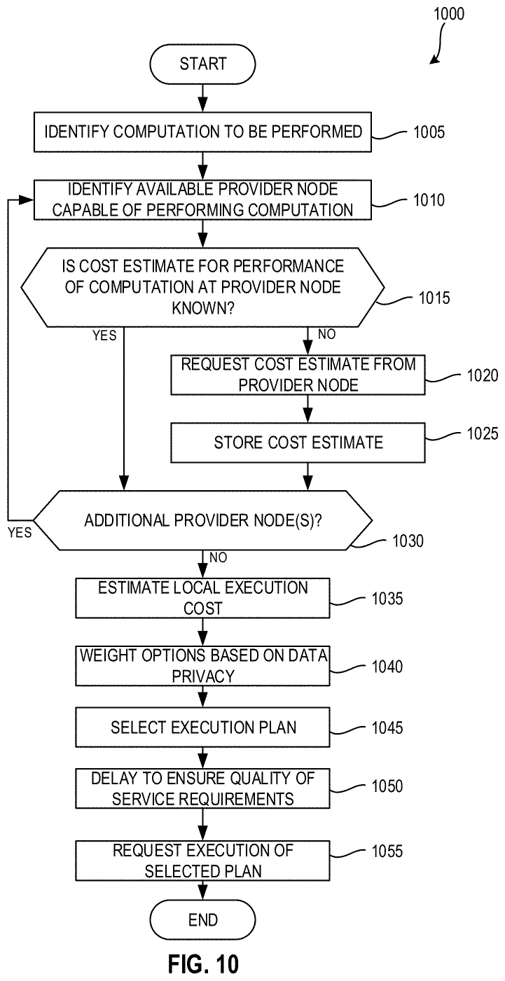

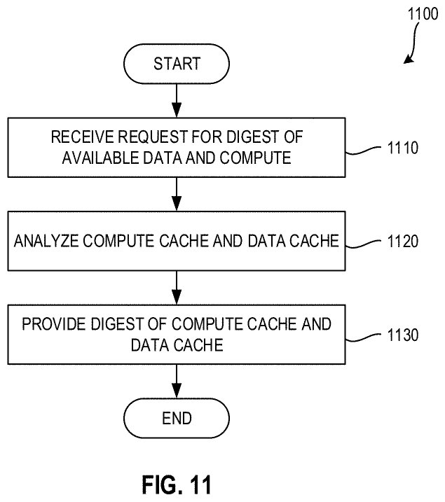

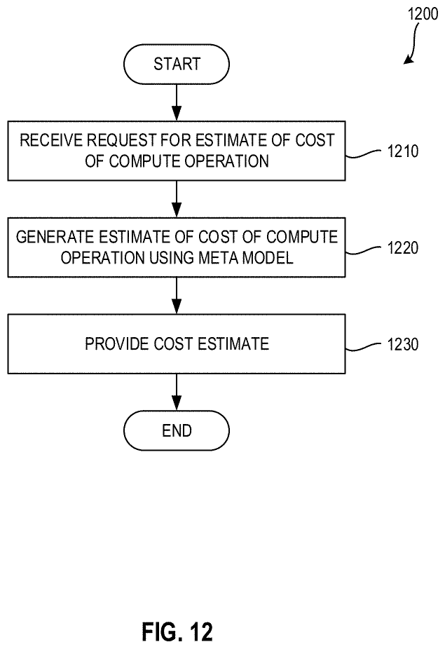

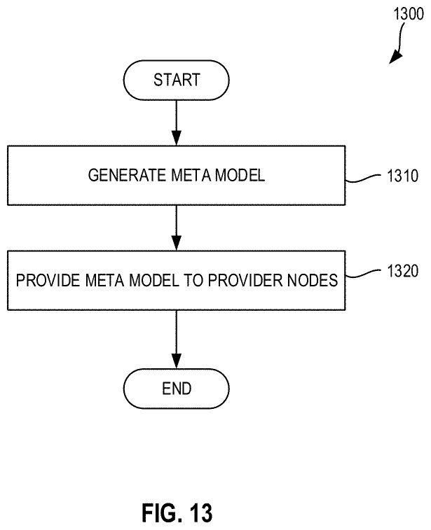

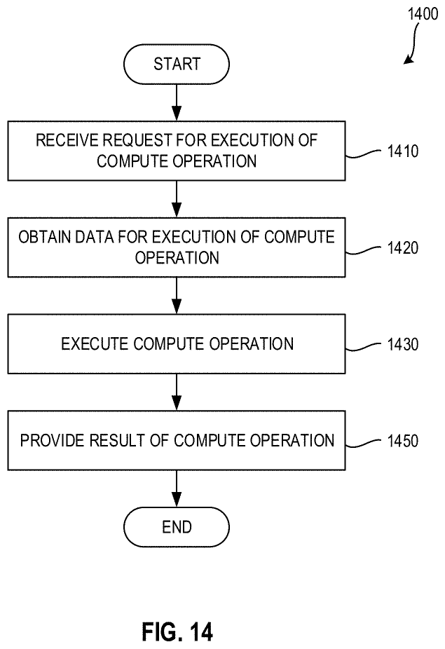

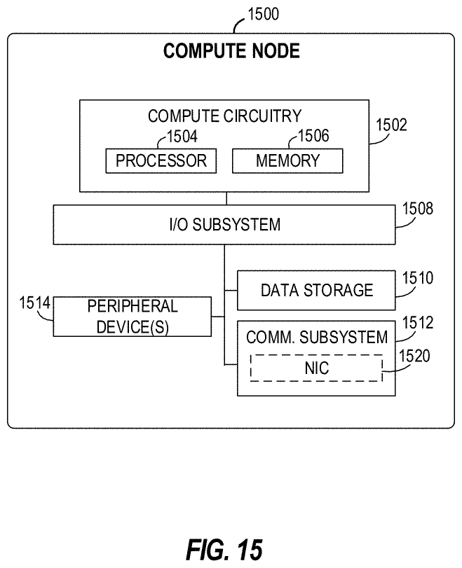

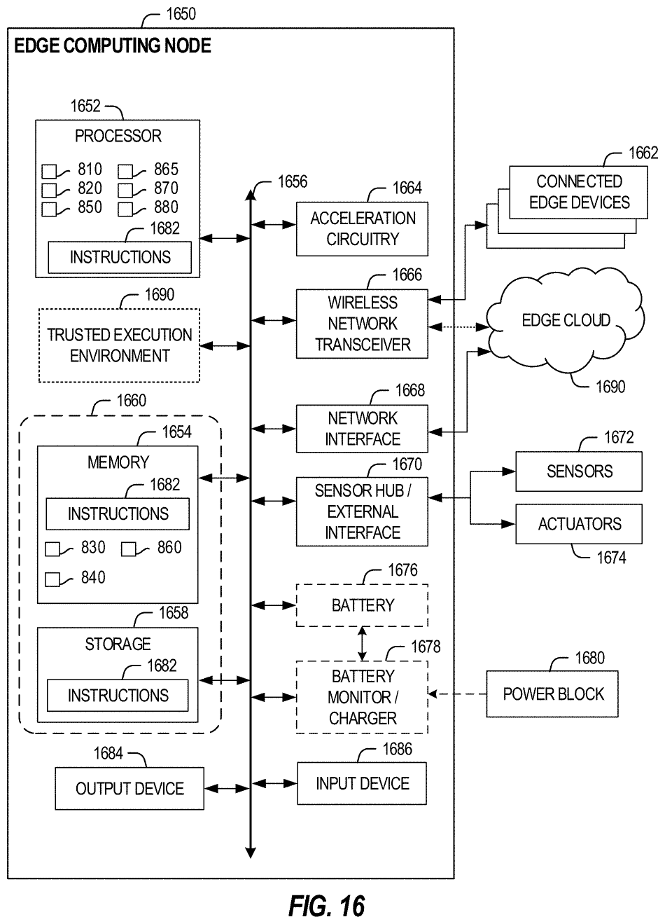

FIG. 16 is another block diagram of an example implementation of the example provider node of FIGS. 6 and/or 7 that may be deployed in one of the edge computing systems illustrated in FIGS. 1-4 and/or 6.

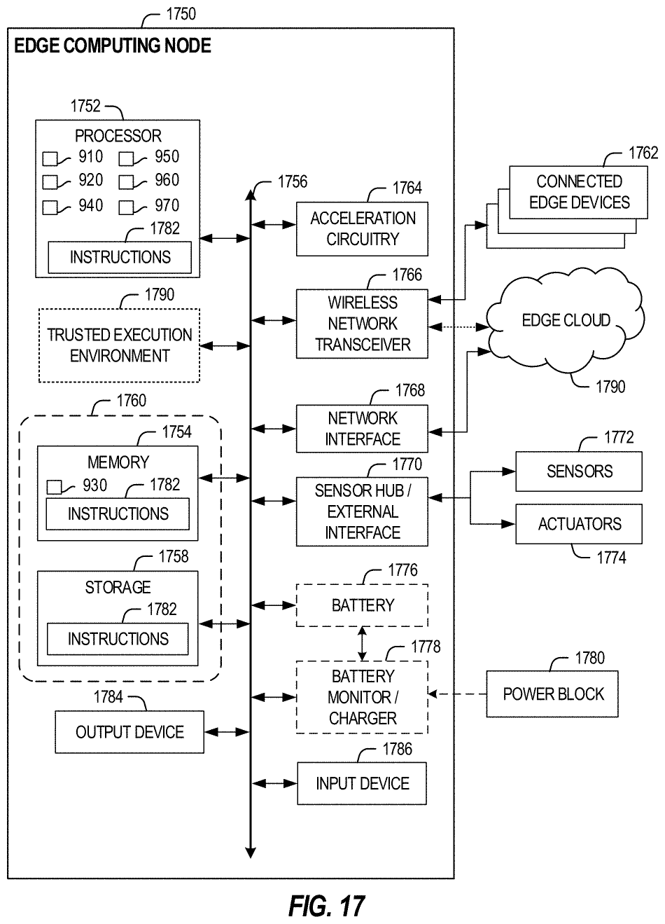

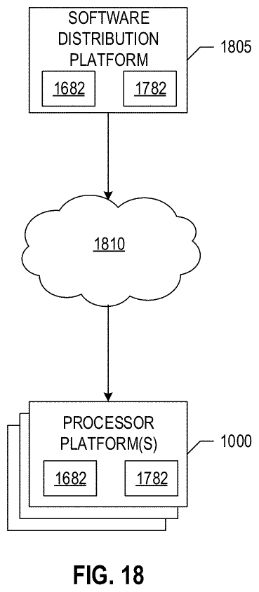

FIG. 17 is another block diagram of an example implementation of the example consumer node of FIGS. 6 and/or 8 that may be deployed in one of the edge computing systems illustrated in FIGS. 1-4 and/or 6.

FIG. 18 is a block diagram of an example software distribution platform to distribute software (e.g., software corresponding to the example computer readable instructions of FIGS. 10, 11, 12, 13, and/or 14) to client devices such as consumers (e.g., for license, sale and/or use), retailers (e.g., for sale, re-sale, license, and/or sub-license), and/or original equipment manufacturers (OEMs) (e.g., for inclusion in products to be distributed to, for example, retailers and/or to direct buy customers).

The figures are not to scale. In general, the same reference numbers will be used throughout the drawing(s) and accompanying written description to refer to the same or like parts. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc. are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real world imperfections. As used herein “substantially real time” refers to occurrence in a near instantaneous manner recognizing there may be real world delays for computing time, transmission, etc. Thus, unless otherwise specified, “substantially real time” refers to real time+/−1 second.

### DETAILED DESCRIPTION

FIG. 1 is a block diagram 100 showing an overview of a configuration for edge computing, which includes a layer of processing referred to in many of the following examples as an “edge cloud”. As shown, the edge cloud 110 is co-located at an edge location, such as an access point or base station 140, a local processing hub 150, or a central office 120, and thus may include multiple entities, devices, and equipment instances. The edge cloud 110 is located much closer to the endpoint (consumer and producer) data sources 160 (e.g., autonomous vehicles 161, user equipment 162, business and industrial equipment 163, video capture devices 164, drones 165, smart cities and building devices 166, sensors and IoT devices 167, etc.) than the cloud data center 130. Compute, memory, and storage resources which are offered at the edges in the edge cloud 110 are critical to providing ultra-low latency response times for services and functions used by the endpoint data sources 160 as well as reduce network backhaul traffic from the edge cloud 110 toward cloud data center 130 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the amount of resources needed for network services, through the distribution of more resources which are located closer both geographically and in network access time. In this manner, edge computing attempts to bring the compute resources to the workload data where appropriate, or, bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data (e.g., at a “local edge”, “close edge”, or “near edge”). For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

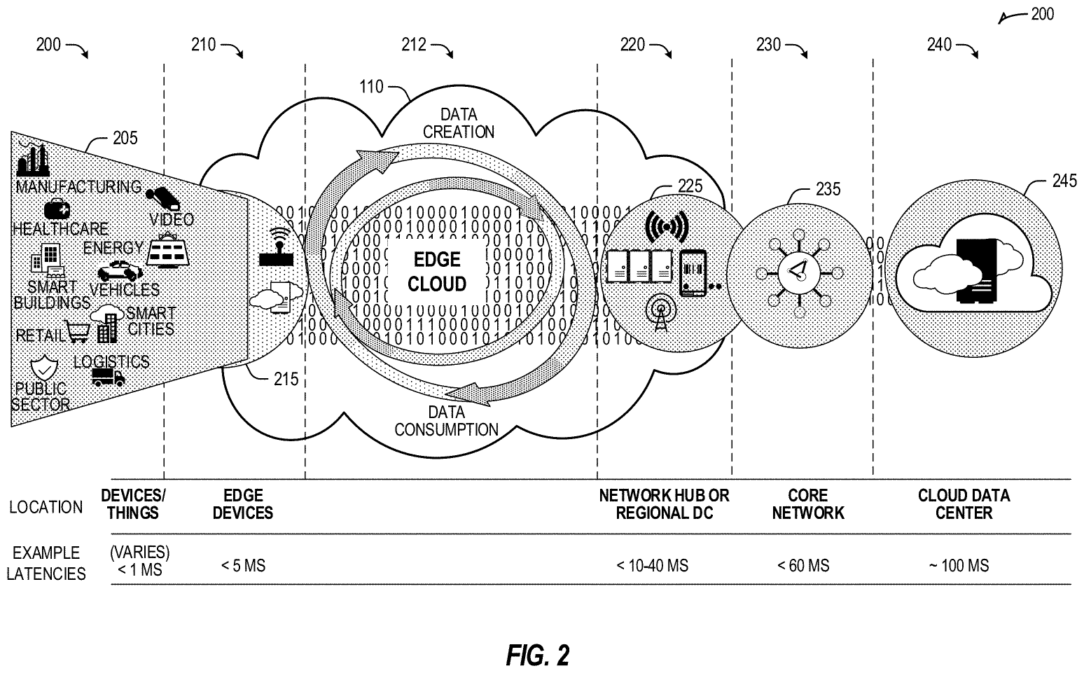

FIG. 2 illustrates operational layers among endpoints, an edge cloud, and cloud computing environments. Specifically, FIG. 2 depicts examples of computational use cases 205, utilizing the edge cloud 110 among multiple illustrative layers of network computing. The layers begin at an endpoint (devices and things) layer 200, which accesses the edge cloud 110 to conduct data creation, analysis, and data consumption activities. The edge cloud 110 may span multiple network layers, such as an edge devices layer 210 having gateways, on-premise servers, or network equipment (nodes 215) located in physically proximate edge systems; a network access layer 220, encompassing base stations, radio processing units, network hubs, regional data centers (DC), or local network equipment (equipment 225); and any equipment, devices, or nodes located therebetween (in layer 212, not illustrated in detail). The network communications within the edge cloud 110 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 200, under 5 ms at the edge devices layer 210, to even between 10 to 40 ms when communicating with nodes at the network access layer 220. Beyond the edge cloud 110 are core network 230 and cloud data center 240 layers, each with increasing latency (e.g., between 50-60 ms at the core network layer 230, to 100 or more ms at the cloud data center layer). As a result, operations at a core network data center 235 or a cloud data center 245, with latencies of at least 50 to 100 ms or more, will not be able to accomplish many time-critical functions of the use cases 205. Each of these latency values are provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center 235 or a cloud data center 245, a central office or content data network may be considered as being located within a “near edge” layer (“near” to the cloud, having high latency values when communicating with the devices and endpoints of the use cases 205), whereas an access point, base station, on-premise server, or network gateway may be considered as located within a “far edge” layer (“far” from the cloud, having low latency values when communicating with the devices and endpoints of the use cases 205). It will be understood that other categorizations of a particular network layer as constituting a “close”, “local”, “near”, “middle”, or “far” edge may be based on latency, distance, number of network hops, or other measurable characteristics, as measured from a source in any of the network layers 200-240. The various use cases 205 may access resources under usage pressure from incoming streams, due to multiple services utilizing the edge cloud. To achieve results with low latency, the services executed within the edge cloud 110 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to SLA, the system as a whole (components in the transaction) may provide the ability to (1) understand the impact of the SLA violation, and (2) augment other components in the system to resume overall transaction SLA, and (3) implement steps to remediate.

Thus, with these variations and service features in mind, edge computing within the edge cloud 110 may provide the ability to serve and respond to multiple applications of the use cases 205 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), standard processes, etc.), which cannot leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because edge locations may be unmanned and may even need permissioned access (e.g., when housed in a third-party location). Such issues are magnified in the edge cloud 110 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 110 (network layers 200-240), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 110.

As such, the edge cloud 110 is formed from network components and functional features operated by and within edge gateway nodes, edge aggregation nodes, or other edge compute nodes among network layers 210-230. The edge cloud 110 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 110 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

The network components of the edge cloud 110 may be servers, multi-tenant servers, appliance computing devices, and/or any other type of computing devices. For example, the edge cloud 110 may include an appliance computing device that is a self-contained electronic device including a housing, a chassis, a case or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.) and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein and/or attached thereto. Output devices may include displays, touchscreens, lights, LEDs, speakers, I/O ports (e.g., USB), etc. In some circumstances, edge devices are devices presented in the network for a specific purpose (e.g., a traffic light), but may have processing and/or other capacities that may be utilized for other purposes. Such edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. 15. The edge cloud 110 may also include one or more servers and/or one or more multi-tenant servers. Such a server may include an operating system and a virtual computing environment. A virtual computing environment may include a hypervisor managing (spawning, deploying, destroying, etc.) one or more virtual machines, one or more containers, etc. Such virtual computing environments provide an execution environment in which one or more applications and/or other software, code or scripts may execute while being isolated from one or more other applications, software, code or scripts.

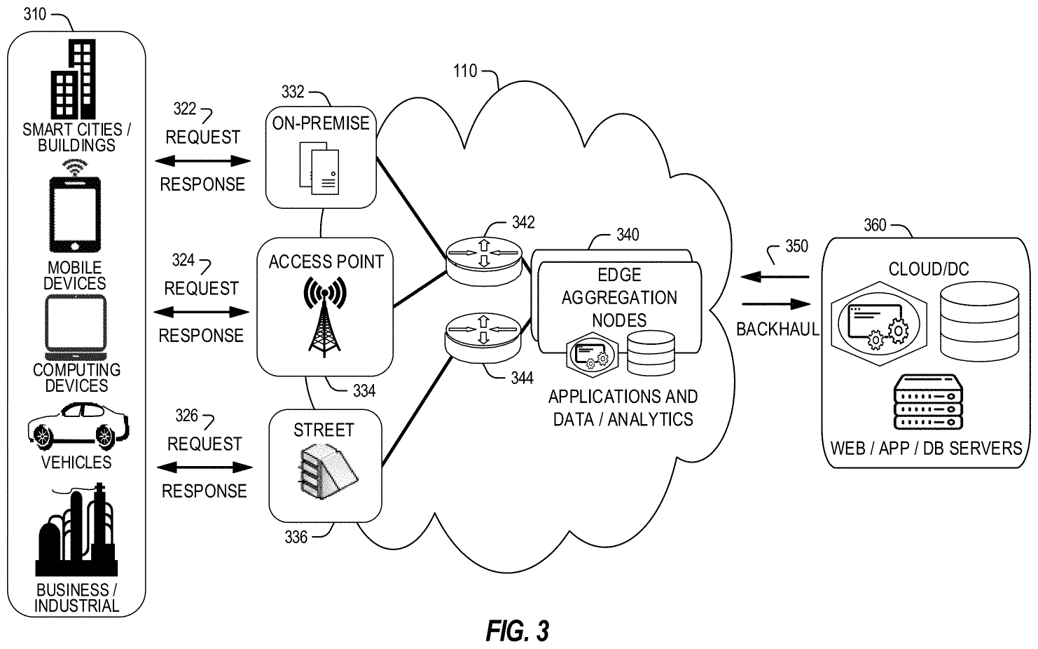

FIG. 3 illustrates a block diagram of an example environment 300 in which various client endpoints 310 (in the form of mobile devices, computers, autonomous vehicles, business computing equipment, industrial processing equipment, etc.) exchange requests and responses with the example edge cloud 110. For instance, client endpoints 310 may obtain network access via a wired broadband network, by exchanging requests and responses 322 through an on-premise network system 332. Some client endpoints 310, such as mobile computing devices, may obtain network access via a wireless broadband network, by exchanging requests and responses 324 through an access point (e.g., cellular network tower) 334. Some client endpoints 310, such as autonomous vehicles may obtain network access for requests and responses 326 via a wireless vehicular network through a street-located network system 336. However, regardless of the type of network access, the TSP may deploy aggregation points 342, 344 within the edge cloud 110 to aggregate traffic and requests. Thus, within the edge cloud 110, the TSP may deploy various compute and storage resources, such as at edge aggregation nodes 340, to provide requested content. The edge aggregation nodes 340 and other systems of the edge cloud 110 are connected to a cloud or data center 360, which uses a backhaul network 350 to fulfill higher-latency requests from a cloud/data center for websites, applications, database servers, etc. Additional or consolidated instances of the edge aggregation nodes 340 and the aggregation points 342, 344, including those deployed on a single server framework, may also be present within the edge cloud 110 or other areas of the TSP infrastructure.

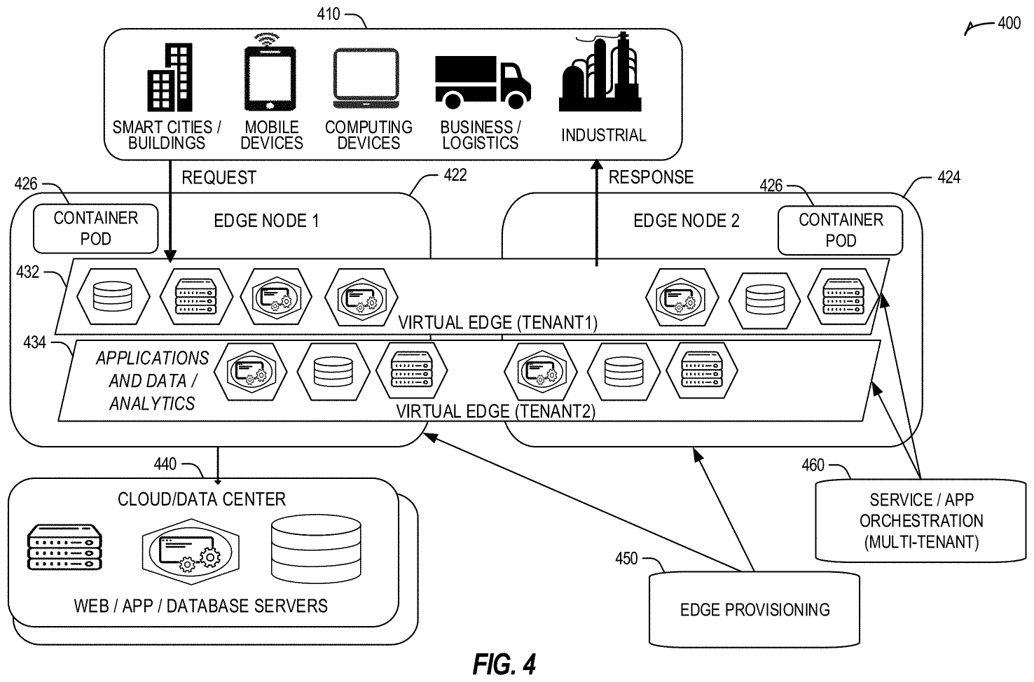

FIG. 4 illustrates deployment and orchestration for virtual edge configurations across an edge computing system operated among multiple edge nodes and multiple tenants. Specifically, FIG. 4 depicts coordination of a first edge node 422 and a second edge node 424 in an edge computing system 400, to fulfill requests and responses for various client endpoints 410 (e.g., smart cities/building systems, mobile devices, computing devices, business/logistics systems, industrial systems, etc.), which access various virtual edge instances. Here, the virtual edge instances 432, 434 provide edge compute capabilities and processing in an edge cloud, with access to a cloud/data center 440 for higher-latency requests for websites, applications, database servers, etc. However, the edge cloud enables coordination of processing among multiple edge nodes for multiple tenants or entities.

In the example of FIG. 4, these virtual edge instances include: a first virtual edge 432, offered to a first tenant (Tenant 1), which offers a first combination of edge storage, computing, and services; and a second virtual edge 434, offering a second combination of edge storage, computing, and services. The virtual edge instances 432, 434 are distributed among the edge nodes 422, 424, and may include scenarios in which a request and response are fulfilled from the same or different edge nodes. The configuration of the edge nodes 422, 424 to operate in a distributed yet coordinated fashion occurs based on edge provisioning functions 450. The functionality of the edge nodes 422, 424 to provide coordinated operation for applications and services, among multiple tenants, occurs based on orchestration functions 460.

It should be understood that some of the devices 410 are multi-tenant devices where Tenant 1 may function within a tenant1 ‘slice’ while a Tenant 2 may function within a tenant2 ‘slice’ (and, in further examples, additional or sub-tenants may exist; and each tenant may even be specifically entitled and transactionally tied to a specific set of features all the way day to specific hardware features). A trusted multi-tenant device may further contain a tenant-specific cryptographic key such that the combination of key and slice may be considered a “root of trust” (RoT) or tenant specific RoT. A RoT may further be computed dynamically composed using a DICE (Device Identity Composition Engine) architecture such that a single DICE hardware building block may be used to construct layered trusted computing base contexts for layering of device capabilities (such as a Field Programmable Gate Array (FPGA)). The RoT may further be used for a trusted computing context to enable a “fan-out” that is useful for supporting multi-tenancy. Within a multi-tenant environment, the respective edge nodes 422, 424 may operate as security feature enforcement points for local resources allocated to multiple tenants per node. Additionally, tenant runtime and application execution (e.g., in instances 432, 434) may serve as an enforcement point for a security feature that creates a virtual edge abstraction of resources spanning potentially multiple physical hosting platforms. Finally, the orchestration functions 460 at an orchestration entity may operate as a security feature enforcement point for marshalling resources along tenant boundaries.

Edge computing nodes may partition resources (memory, central processing unit (CPU), graphics processing unit (GPU), interrupt controller, input/output (I/O) controller, memory controller, bus controller, etc.) where respective partitionings may contain a RoT capability and where fan-out and layering according to a DICE model may further be applied to Edge Nodes. Cloud computing nodes consisting of containers, FaaS engines, Servlets, servers, or other computation abstraction may be partitioned according to a DICE layering and fan-out structure to support a RoT context for each. Accordingly, the respective devices 410, 422, and 440 spanning RoTs may coordinate the establishment of a distributed trusted computing base (DTCB) such that a tenant-specific virtual trusted secure channel linking all elements end to end can be established.

Further, it will be understood that a container may have data or workload specific keys protecting its content from a previous edge node. As part of migration of a container, a pod controller at a source edge node may obtain a migration key from a target edge node pod controller where the migration key is used to wrap the container-specific keys. When the container/pod is migrated to the target edge node, the unwrapping key is exposed to the pod controller that then decrypts the wrapped keys. The keys may now be used to perform operations on container specific data. The migration functions may be gated by properly attested edge nodes and pod managers (as described above).

In further examples, an edge computing system is extended to provide for orchestration of multiple applications through the use of containers (a contained, deployable unit of software that provides code and needed dependencies) in a multi-owner, multi-tenant environment. A multi-tenant orchestrator may be used to perform key management, trust anchor management, and other security functions related to the provisioning and lifecycle of the trusted ‘slice’ concept in FIG. 4. For instance, an edge computing system may be configured to fulfill requests and responses for various client endpoints from multiple virtual edge instances (and, from a cloud or remote data center). The use of these virtual edge instances may support multiple tenants and multiple applications (e.g., augmented reality (AR)/virtual reality (VR), enterprise applications, content delivery, gaming, compute offload) simultaneously. Further, there may be multiple types of applications within the virtual edge instances (e.g., normal applications; latency sensitive applications; latency-critical applications; user plane applications; networking applications; etc.). The virtual edge instances may also be spanned across systems of multiple owners at different geographic locations (or, respective computing systems and resources which are co-owned or co-managed by multiple owners).

For instance, each of the edge nodes 422, 424 may implement the use of containers, such as with the use of a container “pod” 426, 428 providing a group of one or more containers. In a setting that uses one or more container pods, a pod controller or orchestrator is responsible for local control and orchestration of the containers in the pod. Various edge node resources (e.g., storage, compute, services, depicted with hexagons) provided for the respective edge slices 432, 434 are partitioned according to the needs of each container.

With the use of container pods, a pod controller oversees the partitioning and allocation of containers and resources. The pod controller receives instructions from an orchestrator (e.g., the orchestrator 460) that instructs the controller on how best to partition physical resources and for what duration, such as by receiving key performance indicator (KPI) targets based on SLA contracts. The pod controller determines which container requires which resources and for how long in order to complete the workload and satisfy the SLA. The pod controller also manages container lifecycle operations such as: creating the container, provisioning it with resources and applications, coordinating intermediate results between multiple containers working on a distributed application together, dismantling containers when workload completes, and the like. Additionally, a pod controller may serve a security role that prevents assignment of resources until the right tenant authenticates or prevents provisioning of data or a workload to a container until an attestation result is satisfied.

Also, with the use of container pods, tenant boundaries can still exist but in the context of each pod of containers. If each tenant specific pod has a tenant specific pod controller, there will be a shared pod controller that consolidates resource allocation requests to avoid typical resource starvation situations. Further controls may be provided to ensure attestation and trustworthiness of the pod and pod controller. For instance, the orchestrator 460 may provision an attestation verification policy to local pod controllers that perform attestation verification. If an attestation satisfies a policy for a first tenant pod controller but not a second tenant pod controller, then the second pod could be migrated to a different edge node that does satisfy it. Alternatively, the first pod may be allowed to execute and a different shared pod controller is installed and invoked prior to the second pod executing.

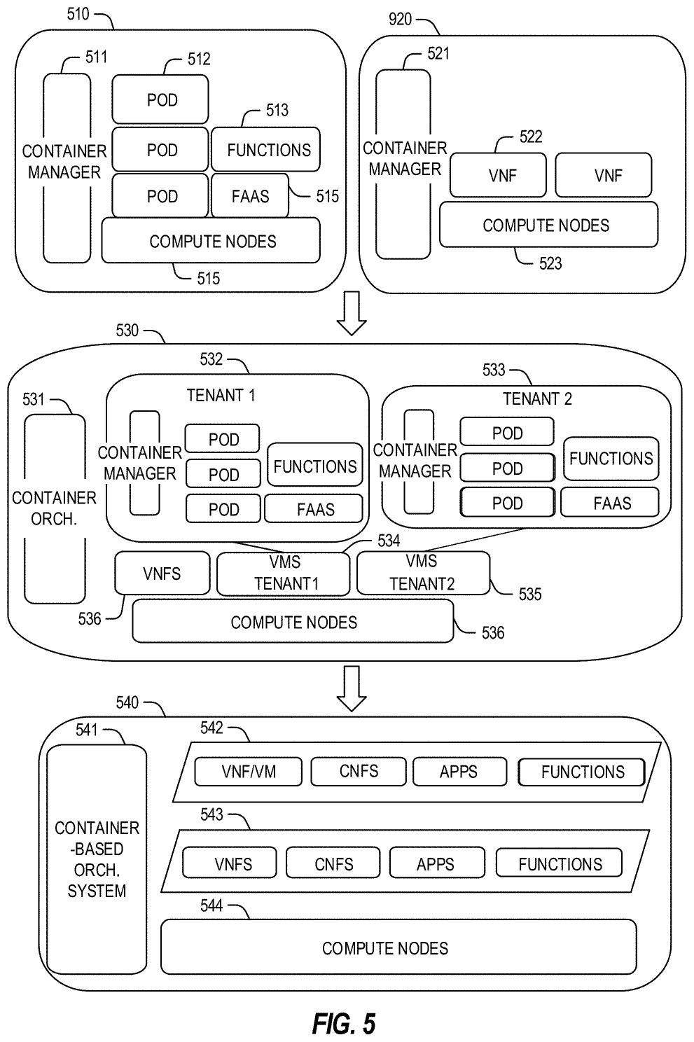

FIG. 5 illustrates additional compute arrangements deploying containers in an edge computing system. As a simplified example, system arrangements 510, 520 depict settings in which a pod controller (e.g., container managers 511, 521, and a container orchestrator 531) is adapted to launch containerized pods, functions, and functions-as-a-service instances through execution via compute nodes (515 in arrangement 510), or to separately execute containerized virtualized network functions through execution via compute nodes (523 in arrangement 520). This arrangement is adapted for use of multiple tenants in an example system arrangement 530 (using compute nodes 536), where containerized pods (e.g., pods 512), functions (e.g., functions 513, VNFs 522, 536), and functions-as-a-service instances (e.g., FaaS instance 514) are launched within virtual machines (e.g., VMs 534, 535 for tenants 532, 533) specific to respective tenants (aside the execution of virtualized network functions). This arrangement is further adapted for use in system arrangement 540, which provides containers 542, 543, or execution of the various functions, applications, and functions on compute nodes 544, as coordinated by an container-based orchestration system 541.

The system arrangements of depicted in FIG. 5 provides an architecture that treats VMs, Containers, and Functions equally in terms of application composition (and resulting applications are combinations of these three ingredients). Each ingredient may involve use of one or more accelerator (FPGA, ASIC) components as a local backend. In this manner, applications can be split across multiple edge owners, coordinated by an orchestrator.

In the context of FIG. 5, the pod controller/container manager, container orchestrator, and individual nodes may provide a security enforcement point. However, tenant isolation may be orchestrated where the resources allocated to a tenant are distinct from resources allocated to a second tenant, but edge owners cooperate to ensure resource allocations are not shared across tenant boundaries. Or, resource allocations could be isolated across tenant boundaries, as tenants could allow “use” via a subscription or transaction/contract basis. In these contexts, virtualization, containerization, enclaves and hardware partitioning schemes may be used by edge owners to enforce tenancy. Other isolation environments may include: bare metal (dedicated) equipment, virtual machines, containers, virtual machines on containers, or combinations thereof.

In further examples, aspects of software-defined or controlled silicon hardware, and other configurable hardware, may integrate with the applications, functions, and services an edge computing system. Software defined silicon may be used to ensure the ability for some resource or hardware ingredient to fulfill a contract or service level agreement, based on the ingredient's ability to remediate a portion of itself or the workload (e.g., by an upgrade, reconfiguration, or provision of new features within the hardware configuration itself).

It should be appreciated that the edge computing systems and arrangements discussed herein may be applicable in various solutions, services, and/or use cases involving mobility. As an example, FIG. 6 shows an example simplified vehicle compute and communication use case involving mobile access to applications in an example edge computing system 600 that implements an edge cloud such as the edge cloud 110 of FIG. 1. In this use case, respective client compute nodes 610 may be embodied as in-vehicle compute systems (e.g., in-vehicle navigation and/or infotainment systems) located in corresponding vehicles which communicate with example edge gateway nodes 620 during traversal of a roadway. For instance, the edge gateway nodes 620 may be located in a roadside cabinet or other enclosure built-into a structure having other, separate, mechanical utility, which may be placed along the roadway, at intersections of the roadway, or other locations near the roadway. As respective vehicles traverse along the roadway, the connection between its client compute node 610 and a particular one of the edge gateway nodes 620 may propagate so as to maintain a consistent connection and context for the example client compute node 610. Likewise, mobile edge nodes may aggregate at the high priority services or according to the throughput or latency resolution requirements for the underlying service(s) (e.g., in the case of drones). The respective edge gateway devices 620 include an amount of processing and storage capabilities and, as such, some processing and/or storage of data for the client compute nodes 610 may be performed on one or more of the edge gateway nodes 620.

The edge gateway nodes 620 may communicate with one or more edge resource nodes 640, which are illustratively embodied as compute servers, appliances or components located at or in a communication base station 642 (e.g., a based station of a cellular network). As discussed above, the respective edge resource node(s) 640 include an amount of processing and storage capabilities and, as such, some processing and/or storage of data for the client compute nodes 610 may be performed on the edge resource node(s) 640. For example, the processing of data that is less urgent or important may be performed by the edge resource node(s) 640, while the processing of data that is of a higher urgency or importance may be performed by the edge gateway devices 620 (depending on, for example, the capabilities of each component, or information in the request indicating urgency or importance). Based on data access, data location or latency, work may continue on edge resource nodes when the processing priorities change during the processing activity. Likewise, configurable systems or hardware resources themselves can be activated (e.g., through a local orchestrator) to provide additional resources to meet the new demand (e.g., adapt the compute resources to the workload data).

The edge resource node(s) 640 also communicate with the core data center 650, which may include compute servers, appliances, and/or other components located in a central location (e.g., a central office of a cellular communication network). The example core data center 650 provides a gateway to the global network cloud 660 (e.g., the Internet) for the edge cloud 110 operations formed by the edge resource node(s) 640 and the edge gateway devices 620. Additionally, in some examples, the core data center 650 may include an amount of processing and storage capabilities and, as such, some processing and/or storage of data for the client compute devices may be performed on the core data center 650 (e.g., processing of low urgency or importance, or high complexity).

The edge gateway nodes 620 or the edge resource node(s) 640 may offer the use of stateful applications 632 and a geographic distributed database 634. Although the applications 632 and database 634 are illustrated as being horizontally distributed at a layer of the edge cloud 110, it will be understood that resources, services, or other components of the application may be vertically distributed throughout the edge cloud (including, part of the application executed at the client compute node 610, other parts at the edge gateway nodes 620 or the edge resource node(s) 640, etc.). Additionally, as stated previously, there can be peer relationships at any level to meet service objectives and obligations. Further, the data for a specific client or application can move from edge to edge based on changing conditions (e.g., based on acceleration resource availability, following the car movement, etc.). For instance, based on the “rate of decay” of access, prediction can be made to identify the next owner to continue, or when the data or computational access will no longer be viable. These and other services may be utilized to complete the work that is needed to keep the transaction compliant and lossless.

In further scenarios, a container 636 (or pod of containers) may be flexibly migrated from one of the edge nodes 620 to other edge nodes (e.g., another one of edge nodes 620, one of the edge resource node(s) 640, etc.) such that the container with an application and workload does not need to be reconstituted, re-compiled, re-interpreted in order for migration to work. However, in such settings, there may be some remedial or “swizzling” translation operations applied. For example, the physical hardware at the edge resource node(s) 640 may differ from the hardware at the edge gateway nodes 620 and therefore, the hardware abstraction layer (HAL) that makes up the bottom edge of the container will be re-mapped to the physical layer of the target edge node. This may involve some form of late-binding technique, such as binary translation of the HAL from the container native format to the physical hardware format, or may involve mapping interfaces and operations. A pod controller may be used to drive the interface mapping as part of the container lifecycle, which includes migration to/from different hardware environments.

The scenarios encompassed by FIG. 6 may utilize various types of mobile edge nodes, such as an edge node hosted in a vehicle (car/truck/tram/train) or other mobile unit, as the edge node will move to other geographic locations along the platform hosting it. With vehicle-to-vehicle communications, individual vehicles may even act as network edge nodes for other cars, (e.g., to perform caching, reporting, data aggregation, etc.). Thus, it will be understood that the application components provided in various edge nodes may be distributed in static or mobile settings, including coordination between some functions or operations at individual endpoint devices or the edge gateway nodes 620, some others at the edge resource node(s) 640, and others in the core data center 650 or global network cloud 660.

In further configurations, the edge computing system may implement FaaS computing capabilities through the use of respective executable applications and functions. In an example, a developer writes function code (e.g., “computer code” herein) representing one or more computer functions, and the function code is uploaded to a FaaS platform provided by, for example, an edge node or data center. A trigger such as, for example, a service use case or an edge processing event, initiates the execution of the function code with the FaaS platform.

In an example of FaaS, a container is used to provide an environment in which function code (e.g., an application which may be provided by a third party) is executed. The container may be any isolated-execution entity such as a process, a Docker or Kubernetes container, a virtual machine, etc. Within the edge computing system, various datacenter, edge, and endpoint (including mobile) devices are used to “spin up” functions (e.g., activate and/or allocate function actions) that are scaled on demand. The function code gets executed on the physical infrastructure (e.g., edge computing node) device and underlying virtualized containers. Finally, container is “spun down” (e.g., deactivated and/or deallocated) on the infrastructure in response to the execution being completed.

Further aspects of FaaS may enable deployment of edge functions in a service fashion, including a support of respective functions that support edge computing as a service (Edge-as-a-Service or “EaaS”). Additional features of FaaS may include: a granular billing component that enables customers (e.g., computer code developers) to pay only when their code gets executed; common data storage to store data for reuse by one or more functions; orchestration and management among individual functions; function execution management, parallelism, and consolidation; management of container and function memory spaces; coordination of acceleration resources available for functions; and distribution of functions between containers (including “warm” containers, already deployed or operating, versus “cold” which require initialization, deployment, or configuration).

The edge computing system 600 can include or be in communication with an edge provisioning node 644. The edge provisioning node 644 can distribute software such as the example computer readable instructions 782 of FIG. 7B, to various receiving parties for implementing any of the methods described herein. The example edge provisioning node 644 may be implemented by any computer server, home server, content delivery network, virtual server, software distribution system, central facility, storage device, storage node, data facility, cloud service, etc., capable of storing and/or transmitting software instructions (e.g., code, scripts, executable binaries, containers, packages, compressed files, and/or derivatives thereof) to other computing devices. Component(s) of the example edge provisioning node 644 may be located in a cloud, in a local area network, in an edge network, in a wide area network, on the Internet, and/or any other location communicatively coupled with the receiving party(ies). The receiving parties may be customers, clients, associates, users, etc. of the entity owning and/or operating the edge provisioning node 644. For example, the entity that owns and/or operates the edge provisioning node 644 may be a developer, a seller, and/or a licensor (or a customer and/or consumer thereof) of software instructions such as the example computer readable instructions 782 of FIG. 7B. The receiving parties may be consumers, service providers, users, retailers, OEMs, etc., who purchase and/or license the software instructions for use and/or re-sale and/or sub-licensing.

In an example, edge provisioning node 644 includes one or more servers and one or more storage devices. The storage devices host computer readable instructions such as the example computer readable instructions 782 of FIG. 7B, as described below. Similarly to edge gateway devices 620 described above, the one or more servers of the edge provisioning node 644 are in communication with a base station 642 or other network communication entity. In some examples, the one or more servers are responsive to requests to transmit the software instructions to a requesting party as part of a commercial transaction. Payment for the delivery, sale, and/or license of the software instructions may be handled by the one or more servers of the software distribution platform and/or via a third party payment entity. The servers enable purchasers and/or licensors to download the computer readable instructions 1682, 1782 from the edge provisioning node 644. For example, the software instructions, which may correspond to the example computer readable instructions 1682, 1782 of FIGS. 16 and/or 17, may be downloaded to the example processor platform/s, which is to execute the computer readable instructions 1682, 1782 to implement the methods described herein.

In some examples, the processor platform(s) that execute the computer readable instructions 1682, 1782 can be physically located in different geographic locations, legal jurisdictions, etc. In some examples, one or more servers of the edge provisioning node 644 periodically offer, transmit, and/or force updates to the software instructions (e.g., the example computer readable instructions 1682, 1782 of FIGS. 16 and/or 17) to ensure improvements, patches, updates, etc. are distributed and applied to the software instructions implemented at the end user devices. In some examples, different components of the computer readable instructions 1682, 1782 can be distributed from different sources and/or to different processor platforms; for example, different libraries, plug-ins, components, and other types of compute modules, whether compiled or interpreted, can be distributed from different sources and/or to different processor platforms. For example, a portion of the software instructions (e.g., a script that is not, in itself, executable) may be distributed from a first source while an interpreter (capable of executing the script) may be distributed from a second source.

In further examples, any of the compute nodes or devices discussed with reference to the present edge computing systems and environment may be fulfilled based on the components depicted in FIGS. 15, 16, and/or 17. Respective edge compute nodes may be embodied as a type of device, appliance, computer, or other “thing” capable of communicating with other edge, networking, or endpoint components. For example, an edge compute device may be embodied as a personal computer, server, smartphone, a mobile compute device, a smart appliance, an in-vehicle compute system (e.g., a navigation system), a self-contained device having an outer case, shell, etc., or other device or system capable of performing the described functions.

A traditional form of edge computing includes transmitting data to an edge node and performing some computation on the data at that edge node. However, transmitting such data from other nodes leads to high latencies and under-utilization of the aggregate computing power available across numerous edge nodes. In newer generation applications, not only are targeted response times for various problem spaces shrinking to a few tens of milliseconds, but the data over which the computations need to be performed is not co-located where the computation must be performed. This leads to both reduction of effective concurrency, as well as communication overheads and inefficiencies of moving data from multiple nodes to a node where the computation must be performed. In many examples, data volumes are large, and data is not generally static. Therefore as the data is updated, the data must be transitioned a number of steps to prepare the data for the requested computation. Thus, one node N1 may perform ingest, and then another node N2 may request a slice or a subset of the ingested (and transformed data), and then a third node N3 may need to transform the data produced by N2, and so on.

In a data center, there are some capabilities—for example Storage Area Networks (SAN)s, to provide consolidated access to data in order to mitigate some aspects of this overhead. However, SANs in general do not scale even in a data center, and increasingly hyperscale storage is used there. Both technologies are ill-matched to the distributed, decentralized, and multi-operator and multi-tenant characteristics common to edge environments. In such architectures, there is too much data and too little allotted time. As such, insights or usages cannot wait until data is ingested, indexed, stored, published, etc., so that it may be consumed for insight and usages. Also, too little power, capacity, etc., at every node, so every node can't be constantly storing and replicating and reconciling data. As such, the SAN approach does not scale. Hyperconverged data solutions allow some amount of scaling but they pose various software integration challenges.

In many examples, computations to be performed do not change frequently. With microservices and FaaS decompositions, compute is typically small in code size and memory compared to data. Further, compute can be implemented in an accelerator, in a CPU, etc, and until it is actually exercised, it does not consume power or CPU time.

In examples disclosed herein, compute can be pre-initialized, suspended, or sourced from neighbors at will. All that is needed is sufficient computational capability (hardware assets, power, etc.) to complete work. At the same time, data is new, has to be ingested, etc., but once ingested, etc., the data does not necessarily have to move, and the right part of compute can be mapped to data, and performed without moving data except perhaps locally for some local transformations.

In many examples, computations produce small sized results, compared to the amount of data over which the computations are performed. Therefore moving results back to where they need to be consumed in other results is generally not a bandwidth or latency amplifier.

Some computations cannot be broken down trivially, and typically have to look at all of data in random access form. Such computations may be implemented iteratively so that the amount of data or results that have to be consumed by nodes in later stages of iteration decrease significantly compared to that in earlier stages of iteration. Rarely, and particularly rarely for low latency edge cases, one may have computations that just don't fit that pattern, and in such cases, it makes sense to have such data be at a sufficiently rich infrastructure (e.g., at a DC cloud, on-prem cloud, etc.).

In some examples, content at the edge is frequently multi-replicated and cached simply because of patterns of usage. For example, many different end users may share video files with one another that are naturally cached at locations in near vicinity of the users. Content Delivery Network (CDN) providers may stream popular content to many locations and thus have opportunities for creating distributions of content at a wide scale.

Considering the above, example approaches disclosed herein introduce an information architecture for edge computing that facilitates decisions about when to move computation to data and when to move data to computation.

FIG. 7 is a block diagram illustrating an example provider node 710 communicating with a consumer node 720 in the edge cloud of FIG. 1. In general, a provider node is a node that performs a computation and provides a result to a consumer node. A consumer node, on the other hand, requests performance of a computation by a provider node. Example detailed implementations of the provider node 710 and the consumer node 720 are described below in connection with FIGS. 7 and 8, respectively.

In examples disclosed herein, both the provider node(s) 710 and the consumer node 720 are considered edge nodes. In some examples, an edge node may be both a consumer node 720 and a provider node 710. For example, an edge node may perform computations on behalf of other edge nodes, and may also request performance of a computation by another edge node. In examples disclosed herein, provider nodes 710 may publish cache-digests for data locally stored at the provider node, and may also publish a listing (e.g., a compute digest) of various compute operations that can be performed on the cached content. The example provider node 710 additionally publishes a handle by which potential requestors (e.g., consumer nodes) can request an estimate for the costs and/or speeds of pushing a given compute operation (and/or multiple computer operations) to the provider node 710. The consumer node 720 utilizes the provided cache digest, the provided compute digest, and/or example cost estimates provided by the provider node to determine which provider node should be requested to perform a computation (and/or where to obtain the data for such a computation).

In examples disclosed herein, for small amounts of cached data, compute operations may be performed locally at the receiver of the data (i.e., if data is small, the data may be transmitted to a compute node). Conversely, for large amounts of cached data, compute operations may be variably transmitted towards the data (e.g., towards the compute engines at the caching nodes). Finally, for streaming data, compute operations may be performed over data while the data is being streamed towards the caching nodes. Thus, computations may be accelerated by catching data as soon as the data reaches the right midway point for caching, especially for data that needs to be decompressed, decrypted, etc. before those compute operations can be applied. Example approaches disclosed herein consider costs of performing such computations to determine where such computations should be performed. Note that in some examples, a consumer node (and/or, more generally, a computing system implementing the consumer node) can also be a provider node, and may choose among the various provider nodes (including itself and/or the same computing system that implements the consumer node) for performance of the computation

In examples disclosed herein, privacy is another element that may be considered for deciding whether data should flow to compute or vice versa. A data owner may prefer that a computation (e.g., a compute algorithm, instructions, code, an applet, a servlet, an edgeless computation) flow to the data to prevent unnecessary disclosure of data to untrusted third parties. However, there is also a privacy consideration for the computation in that the data owner potentially can inspect the code or reverse engineer the computation to glean information on how the computation is performed. Including a privacy weighting factor to influence the selection of a compute location allows for more balanced location selection.

FIG. 8 is a block diagram illustrating an example implementation of the example provider node 710 of FIG. 7. The example provider node 710 of the illustrated example of FIG. 8 includes a network communicator 810, a digest provider 820, a data cache 830, an instruction memory 840, a compute estimator 850, an estimation model cache 860, a model synchronizer 870, and a computation executor 880. In some examples, one or more of the example network communicator 810, the example digest provider 820, the example data cache 830, the example instruction memory 840, the example compute estimator 850, the example estimation model cache 860, the example model synchronizer 870, and/or the example computation executor 880 may be implemented as a component of a Smart Network Interface Card (SmartNIC). Such an approach enables applications and/or cache managers of the provider node 710 to operate at peak efficiency (e.g., no cache pollution or interference with their normal computation workloads) while avoiding latency stretch-outs in making decisions about when to push computation to data and where to push the computations.

In one or more alternative embodiments, many classes of computations that are shipped to data are performed in SmartNICs. In particular, the SmartNICs may perform a distributed computation over different shards or partitions of data distributed across different edge nodes, or, may perform a streaming computation over a number of edge nodes. SmartNIC based approaches may send results to other peer nodes directly, smartNIC-to-smartNIC in some cases; and, in other cases, smartNIC based software may send results of their processing to the local processors (e.g., through shared memory) after having performed various data parallel operations such as map, shuffle, scan, reduce, reduce-by-key, etc. In either example, the applications and/or cache-managers at the host processors run at peak efficiency (e.g., low cache pollution or interference with their normal computation workloads) while avoiding latency stretch-outs by performing computations that are pushed into them to benefit from the content that they store, cache, stream, etc.

The example network communicator 810 of the illustrated example of FIG. 8 is implemented by a server daemon that allows requests received at the provider node 710 to be directed to the appropriate component of the provider node 710. For example, the example network communicator 810 enables requests to be serviced in behalf of the example digest provider 820 (e.g., to inform other nodes of the data and/or computations available to be performed at the provider node 710), the example model synchronizer 870 (e.g., to enable creation of and/or synchronization of estimation models with other node(s)), the example compute estimator 850 (e.g., to enable requests for compute estimates to be serviced), and/or the example computation executor 880 (e.g., to enable requests for execution of computations to be serviced). In some examples, the network communicator 810 is implemented as part of a smart network interface card (SmartNIC).

The example digest provider 820 of the illustrated example of FIG. 8 provides a cache-digest for contents to which the digest provider 820 has access including, for example, stationary content (e.g., content with various object identifiers), streaming content (e.g., content stored with various stream identifiers), etc. In some examples, the content identified by the digest provider 820 is limited to the content stored in the data cache 830 of the provider node 710. However, in some examples the content identified by the digest provider 820 may additionally or alternatively include data that is stored in or provided by another provider node. In addition to the cache digest representing data available to the provider node 710, the example digest provider 820 may provide a compute digest. The example compute digest identifies compute operations that may be performed by the computation executor 880 of the example provider node 710. In examples disclosed herein, the compute digest represents contents of the example instruction memory 840. In some examples, the compute digest identifies whether instructions for a particular computation are already stored in the instruction memory 840, or alternatively, must be retrieved from a separate instruction memory before execution at the computation executor 880 of the provider node 710.

The example data cache 830 of the illustrated example of FIG. 8 is implemented by any memory, storage device and/or storage disc for storing data such as, for example, flash memory, magnetic media, optical media, solid state memory, a solid state disk (SSD) drive (SSDD), hard drive(s), thumb drive(s), etc. Furthermore, the data stored in the example data cache 830 may be in any data format such as, for example, binary data, comma delimited data, tab delimited data, structured query language (SQL) structures, etc. While, in the illustrated example, the data cache 830 is illustrated as a single device, the example data cache 830 and/or any other data storage devices described herein may be implemented by any number and/or type(s) of memories. In the illustrated example of FIG. 8, the example data cache 830 stores data on which the computation executor may operate.

The example instruction memory 840 of the illustrated example of FIG. 8 is implemented by any memory, storage device and/or storage disc for storing data such as, for example, flash memory, magnetic media, optical media, solid state memory, a solid state disk (SSD) drive (SSDD), hard drive(s), thumb drive(s), etc. Furthermore, the data stored in the example instruction memory 840 may be in any data format such as, for example, binary data, comma delimited data, tab delimited data, structured query language (SQL) structures, etc. While, in the illustrated example, the instruction memory 840 is illustrated as a single device, the example instruction memory 840 and/or any other data storage devices described herein may be implemented by any number and/or type(s) of memories. In the illustrated example of FIG. 8, the example instruction memory 840 stores instructions that may be executed by the computation executor. In some examples, the instruction memory 840 may be referred to as an “operations catalogue.” In examples disclosed herein, the instruction memory stores instructions for execution by the provider node to cause the provider node to perform and send back results to a requesting consumer node.

The example compute estimator 850 of the illustrated example of FIG. 8 estimates a cost and/or an amount of time for performing various computations that are advertised by the example digest provider. In examples disclosed herein, the example compute estimator 850 implements one or more estimators that include various models, procedures, equations, spreadsheet solvers, statistical probability distributions, etc. The example compute estimator 850 generates estimates that identify an estimated cost (in energy, time, money, etc.) that it will take to perform a requested calculation, as well as other conditions of such calculation. In examples disclosed herein, the term cost is defined to be any one of a monetary cost (e.g., an amount of money to be charged for performing an operation), a temporal cost (e.g., an amount of time required to complete an operation), an energy cost (e.g., an amount of energy required to complete an operation), and/or a resource cost (e.g., an amount of memory used to complete an operation). In some examples, multiple such costs may be considered. For example, both temporal costs and resource costs may be considered and/or identified when creating an estimate. As such, such estimates may include, for example, “it will take X joules to transcode a 1 TB movie, at a cost of 0.00013 USD per joule, if transcoding is to be performed within a total latency bound of 30 seconds,” “it will take Y seconds to translate a 256 GB corpus of audio in French to text in English, with in an estimated accuracy of 97.8 percent,” “It will take Z dollars to perform and deliver a Top-K result from a dataset of 1 billion records,” etc.

The example compute estimator 850 executes a model stored in the example estimation model cache 860. Such models may include, for example, artificial intelligence and/or machine learning models, equations, regression models, spreadsheet solvers, etc. Such models be provided one or more sets of parameters as inputs and be requested to produce another set of parameters as predicted values or outputs. Such models enable the compute estimator 850 to implement general parameter fits, not requiring that a parameter be only an input parameter or only an output parameter. In this manner, the example compute estimator 850 attempts to solve a constraint problem including, for example, “for a given input parameter constraint (e.g., cost) project a maximum output parameter (e.g., latency), provided that accuracy must be above a threshold amount of accuracy (e.g., ninety five percent). In such an example, accuracy is both an input constraint and an output parameter in this example.

An example constraint may be, for example, “for a given throughput constraint (e.g., min. throughput greater than or equal to 2 Gbps), estimate the minimum cost, provided that the computation is performed inside a secure enclave.” In this example, throughput is both an input constraint and an implicit output parameter that meets or exceeds the constraint, the usage of a secure enclave is an input constraint that specifies a categorical value, and minimum cost is an explicit output parameter. In this manner, the compute estimator 850 produces missing parameters from parameters given to them as inputs in constraint satisfier equations, models, etc.).

In some examples, the compute estimator 850 provides an option to have a length of time as a parameter (either an input parameter or an output parameter) for which the estimates that it generates can be considered viable. Such information enables a consumer node to know how long each estimate is valid. In this manner, computation estimates generated by the compute estimator 850 may be cached by the consumer node such that the compute estimate need not be performed again if it were needed by a consumer node within a threshold amount of time (e.g., while the estimate was valid). In some examples, an operational condition of the provider node 710 may change such that a prior estimate is no longer valid. In such an example, when the consumer node 720 requests execution of the computation, the example compute estimator 850 may generate a new estimate to allow the consumer node 720 decide whether to proceed with the computation.

While in the illustrated example of FIG. 8, the example compute estimator 850 estimates costs of performing a computation at the provider node 710, in some examples, the compute estimator 850 may estimate costs of performing the computation at one or more other provider nodes. In this manner, the compute estimator 850 may estimate costs for a cluster of provider nodes. In this manner, the nodes in the cluster may be considered a content affinity group, and may be identified as such in the cache-digest provided by the digest provider 820. In some examples, a set of nodes that collectively cache different parts of a sharded data set may offer a single estimate for performance of a computation at the cluster level.

The example estimation model cache 860 of the illustrated example of FIG. 8 is implemented by any memory, storage device and/or storage disc for storing data such as, for example, flash memory, magnetic media, optical media, solid state memory, a solid state disk (SSD) drive (SSDD), hard drive(s), thumb drive(s), etc. Furthermore, the data stored in the example estimation model cache 860 may be in any data format such as, for example, binary data, comma delimited data, tab delimited data, structured query language (SQL) structures, etc. While, in the illustrated example, the estimation model cache 860 is illustrated as a single device, the example estimation model cache 860 and/or any other data storage devices described herein may be implemented by any number and/or type(s) of memories. In the illustrated example of FIG. 8, the example estimation model cache 860 stores estimation models that are stored by the example model trainer 865 and/or the example model synchronizer 870 for use by the compute estimator 850.

The example model trainer 865 of the illustrated example of FIG. 8 generates models stored in the estimation model cache 860 for use by the compute estimator 850. In examples disclosed herein, the model used by the compute estimator 850 may be trained or developed asynchronously and/or offline. In some such examples, the model trainer 865 may be implemented at a node where there is sufficient computational assets to build and update such models.

In some examples, the training performed by the model trainer 865 results in creation of a meta model. A meta model provides rules and/or estimations for translating from a model whose coefficients, weights, etc. are developed for one or more reference architecture setting and/or assets, to another architectural setting and/or assets. A meta model enables an edge node to access a trained model developed for a first node to be used by a second edge node having a different architecture. In this manner, the meta model is not trained for the second node, but is usable for creating estimations by the second node nonetheless. In some examples, parameters of the meta model include meta-estimators such as a meta-estimator for core scaling, cache scaling, etc., per trained estimator for each task. In this manner, the meta-estimators enable a reduction in the complexity of spanning every conceivable machine architecture (e.g., from a first processor architecture operating at a first frequency to a second processor architecture operating at a second frequency).

A further objective of the meta-estimators is to account for the amount of resources not available for performing a given task. For example, if a moving average of processor utilization at an edge node is 36.2 percent, and an administrative policy requires that total utilization not exceed 90 percent, then the meta-estimators can be used to pro-rate the CPU as being available at (90-36.2)=0.538, or 53.8 percent) when performing the estimation.

The example model trainer 865 uses historic computation performance metrics associated with prior execution of a computation at the provider node to generate the estimation model. However, any other information may additionally or alternatively be considered when developing the estimation model. The example model trainer 865 stores the trained model in the estimation model cache 860.

The example model synchronizer 870 of the illustrated example of FIG. 8 shares the models stored in the estimation model cache 860 with other provider nodes. In such examples, the model synchronizer 870 shares the models using pull, push, and/or publish-subscribe approaches. In some examples, the model trainer 865 may be implemented along with the model synchronizer 870 at a data center node to allow for creation of the model at a node having additional compute resources. In such an example, models may be trained on demand and then provided to requesting nodes.

The example computation executor 880 the illustrated example of FIG. 8 performs a requested computation at the request of a consumer node. As noted above, the computation executor 880 may execute a computation having corresponding instructions stored in the instruction memory 840 on data stored in the data cache 830 (and/or data retrieved and/or provided by another node). The example computation executor 880 determines a result of the computation and provides the result to the consumer node 720. In some examples, instead of providing the result to the consumer node 720, the result may be provided to another node (e.g., a next-hop node in a sequence of nodes).

FIG. 9 is a block diagram illustrating an example implementation of the example consumer node 720 of FIG. 7. The example consumer node includes a request accessor 910, a cache digest interface 920, a cache digest memory 930, a compute plan solver 940, privacy weighting circuitry 950, a quality of service (QoS) controller 960, and a plan executor 970.

The example request accessor 910 of the illustrated example of FIG. 9 identifies a computation to be performed. Such a computation may be performed on data that is locally present at the consumer node 720 or, alternatively, may be located at another node (e.g., a provider node or some other node, cache, etc.). In some examples, the computation is requested by a processor executing instructions at the consumer node. In some examples, the computation is requested by a third party (e.g., another edge device). The example request accessor 910 provides the request to the compute plan solver 940, which generates potential compute plans, selects a plan, and causes the plan executor 970 to execute the selected plan.

The example cache digest interface 920 of the illustrated example of FIG. 9 communicates with the example digest provider 820 of the example provider node 710 to request cache information concerning the instruction memory 840 and/or the data cache 830. In examples disclosed herein, such communications are performed using a web-based protocol, such as HyperText Transfer Protocol (HTTP), Representational State Transfer (REST), etc. However, any other past, present, and/or future protocol(s) may additionally or alternatively be used. The information obtained by the communications can then be used to make a decision about which nodes should be contacted for compute estimates by the example compute plan solver 940. In some examples, the cache digest interface implements means for identifying.

The example cache digest memory 930 of the illustrated example of FIG. 9 is implemented by any memory, storage device and/or storage disc for storing data such as, for example, flash memory, magnetic media, optical media, solid state memory, a solid state disk (SSD) drive (SSDD), hard drive(s), thumb drive(s), etc. Furthermore, the data stored in the example cache digest memory 930 may be in any data format such as, for example, binary data, comma delimited data, tab delimited data, structured query language (SQL) structures, etc. While, in the illustrated example, the cache digest memory 930 is illustrated as a single device, the example cache digest memory 930 and/or any other data storage devices described herein may be implemented by any number and/or type(s) of memories. In the illustrated example of FIG. 9, the example cache digest memory 930 stores indications of remote instruction memory(ies), which are used to identify which provider nodes can perform which compute operation. The example cache digest memory 930 additionally stores estimates of compute operations provided by the provider node 710.

The example compute plan solver 940 of the illustrated example of FIG. 9 communicates with the example compute estimator 850 of the example provider node 710 to request compute estimates for computations that may be requested, and generate a compute plan based on those estimates. In examples disclosed herein, such communications with the compute estimator 850 are performed using a web-based protocol, such as HyperText Transfer Protocol (HTTP), Representational State Transfer (REST), etc. However, any other past, present, and/or future protocol(s) may additionally or alternatively be used. The information obtained by the communications can then be used by the compute plan solver 940 to generate one or more compute plans. Such compute plans allow the compute plan solver 940 to determine whether to, for example, pull stationary or streaming data towards itself and perform a computation on the pulled data or stream locally, or when to push a computation to be performed to a provider edge node (e.g., a single provider node and/or a cluster of provider nodes). In some examples, the compute plan solver 940 implements means for solving.

In some examples, a compute plan is referred to as an optimization plan. Such compute plans use various parameters concerning the computation to be performed, and parameters concerning where the data needed in that computation at that node is presently cached to divide up the computation into subparts and to request one or more provider nodes to perform the subparts of the computation at the provider nodes. To create the compute plan(s), the compute plan solver consults the cache-digests (via the cache digest memory 930 and/or via the cache digest interface 920) to identify the content and the content operations supported at one or more provider nodes, and request the provider nodes for various output parameters such as costs, latencies, security guarantees, accuracy guarantees, and so on.

In examples disclosed herein, potential compute plans are generated for each different potential computation approach (e.g., utilization of different provider nodes, separation of components of the compute operation into compute portions to be executed by different provider nodes, etc.) In examples disclosed herein, to keep this design space exploration efficient, an optimization plan may generally use prior training, and table lookups, which are performed over the estimates that have been provided recently (e.g., estimates stored in a memory of the consumer node such as, for example, the cache digest memory 930), and where the provided estimates are valid for forward durations in time. The generation of and/or selection of a compute plan may be controlled by various requestor side objectives such as min-cost, max-accuracy, min-latency, min-cost-weighted-latency, etc. In some examples, the compute plan solver 940 interfaces with the privacy weighting circuitry 950 and/or the QoS controller 960 to make a determination as to which compute plan is to be selected for execution. The selected plan is provided to the plan executor 970 for requesting of execution by the provider node(s).

The example privacy weighting circuitry 950 of the illustrated example of FIG. 9 applies weighting values to the potential compute plans based on security and privacy objectives in addition to factors like cost, accuracy, latency, cost-weighted-latency. For example, privacy may be one motivation for deciding whether data should flow to compute or vice versa. In this manner, the data owner may prefer that the compute algorithm/code/applet/servlet/edgeless flow to the data to prevent disclosure of data unnecessarily to untrusted consumers and/or to third party caches. In some examples, privacy may also be a consideration for the owner of a compute algorithm. For example, an applicable objective from a requestor's perspective may be to prevent either a less trusted environment at a cached-content provider node or a less trusted environment at a content-owner node from inspecting the compute algorithm (e.g., code) and reverse-engineering the algorithm to, for example, identify trade-secrets. In some examples, the privacy weighting circuitry 950 implements means for weighting.

To balance such quantitative criteria with qualitative privacy and security criteria outlined, the example privacy weighting circuitry 950 utilizes privacy weighting factors. An example of using a privacy weighting factor from a requestor's standpoint is to specify several weighting factors (e.g., a multiplier). For example, a high multiplier may be used for the cost of performing a computation at a less trusted environment, a low multiplier may be used for the cost of performing a computation at a highly trusted environment, and a medium multiplier for the cost of performing a computation at an intermediate level of trust. Such weighting factors (e.g., high, low, medium, etc) may vary according to the types of algorithm or code (i.e., vary according to the degree to the value that the owner of the algorithm or code assigns to its protection). Such weighting factors are applied to the cost to allow for analysis and/or selection of a compute plan based on the weighted cost(s).

The example QoS controller 960 of the illustrated example of FIG. 9 ensures a uniform quality of service. It is important to build in a notion of fairness alongside data locality. Thus, in examples disclosed herein, the example QoS controller 960 utilizes an out-of-band parameter for driving the scheduling of computations. That out-of-band parameter may be used to represent a rolling entitlement for “compute” cycles across the edge as a whole, and that parameter may result in a requestor delaying its request by a small amount when the requestor has been requesting more than a threshold amount of computations from one or more provider nodes within a threshold period of time. In this manner, the QoS controller 960 acts as a limiter and/or throttler in connection with the plan executor 970 to temporarily limit a number of computations requested from a given provider node by the plan executor 970. In some examples, the QoS controller 960 implements means for delaying.

The example plan executor 970 of the illustrated example of FIG. 9 requests execution of a selected compute plan by one or more provider nodes. When requesting performance of a computation at a provider edge node, the data may be provided to the provider edge node. In some examples, the provider node may be informed of where to obtain the data (e.g., from a local cache of the provider node, from a cache of another provider node, from a third party cache, etc.). In some examples, the plan executor 970 implements means for transmitting.

In this manner, for small amounts of cached data, compute operations may be performed locally at the receiver of the data (i.e., if data is small, it is shipped to a compute node). Conversely, for large volumes of cached data, compute operations may be variably shipped towards the data (i.e., towards the compute engines at the provider node).

In some examples, for streaming data, compute operations may be performed over data while it is being streamed towards the caching nodes. Such streaming compute operations may occur either at one edge node as single-noded operations, or they may occur at multiple edge nodes as streaming operations (e.g., an operation that accepts an input stream and produces an output stream).

As a result, computations are accelerated by catching or intercepting data as soon as the data reaches the right midway point for caching. Such an approach is especially useful for data that is to be decompressed, decrypted, etc. before a compute operation can be applied.

While an example manner of implementing the example provider node 710 and/or the example consumer node 720 are illustrated in FIGS. 7, 8, and/or 9, one or more of the elements, processes and/or devices illustrated in FIGS. 7, 8, and/or 9 may be combined, divided, re-arranged, omitted, eliminated and/or implemented in any other way. Further, the example network communicator 810, the example digest provider 820, the example compute estimator 850, the example model trainer 865, the example model synchronizer 870, the example compute executor 880, and/or, more generally, the example provider node 710 of FIG. 8, the example request accessor 910, the example cache digest interface 930, the example compute plan solver 940, the example privacy weighting circuitry 950, the example QoS controller 960, the example plan executor 970, and/or, more generally, the example consumer node 720 of FIG. 9 may be implemented by hardware, software, firmware and/or any combination of hardware, software and/or firmware. Thus, for example, any of the example network communicator 810, the example digest provider 820, the example compute estimator 850, the example model trainer 865, the example model synchronizer 870, the example compute executor 880, and/or, more generally, the example provider node 710 of FIG. 8, the example request accessor 910, the example cache digest interface 930, the example compute plan solver 940, the example privacy weighting circuitry 950, the example QoS controller 960, the example plan executor 970, and/or, more generally, the example consumer node 720 of FIG. 9 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example network communicator 810, the example digest provider 820, the example compute estimator 850, the example model trainer 865, the example model synchronizer 870, the example compute executor 880, and/or, more generally, the example provider node 710 of FIG. 8, the example request accessor 910, the example cache digest interface 930, the example compute plan solver 940, the example privacy weighting circuitry 950, the example QoS controller 960, the example plan executor 970, and/or, more generally, the example consumer node 720 of FIG. 9 is/are hereby expressly defined to include a non-transitory computer readable storage device or storage disk such as a memory, a digital versatile disk (DVD), a compact disk (CD), a Blu-ray disk, etc. including the software and/or firmware. Further still, the example provider node 710 of FIGS. 7 and/or 8, and/or the example consumer node 720 of FIGS. 7 and/or 9 may include one or more elements, processes and/or devices in addition to, or instead of, those illustrated in FIGS. 7, 8, and/or 9, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

Flowcharts representative of example hardware logic, machine readable instructions, hardware implemented state machines, and/or any combination thereof for implementing the provider node 710 of FIGS. 7 and/or 8, and/or the example consumer node 720 of FIGS. 7 and/or 9 are shown in FIGS. 10, 11, 12, 13, and/or 14. The machine readable instructions may be one or more executable programs or portion(s) of an executable program for execution by a computer processor and/or processor circuitry, such as the processor 1512 shown in the example processor platform 1500 discussed below in connection with FIG. 15. The program may be embodied in software stored on a non-transitory computer readable storage medium such as a CD-ROM, a floppy disk, a hard drive, a DVD, a Blu-ray disk, or a memory associated with the processor 1512, but the entire program and/or parts thereof could alternatively be executed by a device other than the processor 1512 and/or embodied in firmware or dedicated hardware. Further, although the example program is described with reference to the flowcharts illustrated in FIGS. 10, 11, 12, 13, and/or 14, many other methods of implementing the example provider node 710 of FIGS. 7 and/or 8, and/or the example consumer node 720 of FIGS. 7 and/or 9 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement one or more functions that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 10, 11, 12, 13, and/or 14 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIG. 10 is a flowchart representative of example machine readable instructions 1000 that may be executed to implement the example consumer node of FIGS. 7 and/or 9. The example instructions 1000 of the illustrated example of FIG. 10 begin when the example request accessor 910 identifies the computation to be performed. (Block 1005). The example cache digest interface 930 identifies an available provider node capable of performing the request to computation. (Block 1010). The example compute plan solver 940 determines whether a cost estimate for performance of the computation at the identified provider node is known. (Block 1015). The example compute plan solver 940 determines whether the cost estimate is known by querying the cache digest memory 930 of the consumer node 720 to determine whether a recent estimate for the performance the computation has been stored. In some examples, an estimate may be considered to be recent when a threshold amount of time from which the estimate was provided has not yet elapsed. In some examples, the threshold amount of time may vary based on an instruction (e.g., a validity window) from the providing provider node. Different provider nodes, and even different validity thresholds for a same provider node, may be used. For example, a first provider node may indicate that a first estimate is valid for one minute, while a second provider node may indicate that a second estimate is valid for thirty minutes. Additionally alternatively, a fixed threshold may be used by the consumer node e.g. thirty minutes, sixty minutes, one day, etc.

If the example compute plan solver 940 determines that the cost estimate for the performance of the computation of the identified provider node is not known (e.g., block 1015 returns a result of NO), the example cache digest interface 930 requests the cost estimate from the provider node. (Block 1020). The example cache digest interface 930 stores the cost estimate in the cache digest memory 930. (Block 1025). In this manner, estimates for performance of a given computation can be reused for the threshold amount of time by the example compute plan solver 940.

Returning to block 1015, if the example compute plan solver 940 determines that the cost of estimate for performance of the computation at the identified provider node is known (e.g., block 1015 returns result of YES), the example compute plan solver 940 determines whether any additional provider nodes can be identified for potential performance of the requested computation. (Block 1030). If additional provider nodes are available for performance of the computation control returns to block 1010 where the example cache digest interface 930 identifies the node, and a cost estimate is retrieved, if such retrieval is necessary. In some examples, a policy may be used to determine if a sufficient number of estimates from provider nodes have been collected. In this manner, the example compute plan solver 940 may proceed to block 1035 after a threshold number of estimates have been collected. Such an approach removes the need for the compute plan solver 940 to retrieve estimates from every possible provider node and, instead, base the subsequent decision of where a computation is to be performed on a sufficient number of compute cost estimates.

Upon determining that estimates are available for all, or a sufficient number of, provider nodes that can perform the computation (e.g., block 1030 returning result of NO), the example compute plan solver 940 estimates local execution costs. (Block 1035). In this manner, local execution costs allow the example consumer node 720 to determine whether it is more cost-effective to perform the requested computation locally, as opposed to requesting a remote provider node perform such computation. The example privacy waiting circuit 950 applies waiting values to the various costs based on data privacy. (Block 1040). Different waiting values may be applied based on, for example whether the data on which the computation is to be performed is highly sensitive, whether the instructions associated with the computation are highly sensitive and cannot be moved to a different node for execution, etc.

The example compute plan solver 940 selects an execution plan. (Block 1045). In some examples, the plan having the lowest cost is selected. However, other criteria and or values may be used in determining which execution plan to select. In examples disclosed herein, the term cost does not necessarily refer to a monetary cost, but could additionally or alternatively refer to a temporal cost (e.g., amount of time to perform the computation, an amount of energy required to perform the computation, etc.) Moreover, cost may refer to an aggregate cost of performing a requested operation. For example, if a first node can perform a requested operation in a cost of ten units, but the operation could be broken down into a first and second step each performed by a respective second and third node, each having a cost of seven units (for a total cost of fourteen units), it may be more cost effective to request performance of the operation at the first node rather than the second and third nodes, despite each of the second and third nodes individually estimating the lowest costs.

Based on the node(s) associated with the selected execution plan, the example QOS controller 960 delays some amount of time to ensure quality of service. (Block 1050). In examples disclosed herein, the example QoS controller 960 utilizes an out-of-band parameter for driving the scheduling of computations. The out-of-band parameter may be used to represent a rolling entitlement for “compute” cycles across the edge as a whole, and that parameter may result in a requestor delaying its request by a small amount when the requestor has been requesting more than a threshold amount of computations from one or more provider nodes within a threshold period of time. In this manner, the QoS controller 960 acts as a limiter and/or throttler in connection with the plan executor 970 to temporarily limit a number of computations requested from a given provider node by the plan executor 970.

The example plan executor 970 then requests execution of the selected plan. (Block 1055). The example process 1000 the illustrated example of FIG. 10 then terminates, but may be re-executed upon, for example, identification of the subsequent computation to be performed.

FIG. 11 is a flowchart representative of example machine readable instructions 1100 that may be executed to implement the example provider node of FIGS. 7 and/or 8 to provide digest information to an example consumer node. The example process 1100 of the illustrated example of FIG. 11 begins when the example network communicator 812 receives a request for a digest of available data and compute. (Block 1110). The example digest provider 820 analyzes the instruction memory 840 and the data cache 830 to generate a cache digest. (Block 1120). The cache digest identifies, for example, data locally cached at the provider node (e.g., in the data cache 830) and/or compute instructions that are stored in the instruction memory 840 (e.g. representing compute operations that can be performed by the provider node 710. The example digest provider provides the generated digest of the instruction memory and the data cache as a response to the request for the digest. (Block 1130). The example process 1100 of the illustrated example of FIG. 11 may then be repeated upon subsequent receipt of request for the digest.

While in the illustrated example of FIG. 11, the digest identifies both the computations that can be performed at the provider node in the data cache that the provider node, in some examples such digests may be provided and/or requested separately. For example, a compute digest may be provided separately from a data digest.

FIG. 12 is a flowchart representative of example machine readable instructions 1200 that may be executed to implement the example provider node of FIGS. 7 and/or 8 to provide a cost estimate of performing a computation. The example process 1200 of the illustrated example of FIG. 12 begins when the example network communicator 810 receives a request for an estimate of the cost of performing a compute operation. (Block 1210). The example compute estimator 850, using a model stored in the estimation model cache 860, generates an estimate of the cost of performing the computation. (Block 1220). Such models may include, for example, artificial intelligence and/or machine learning models, equations, regression models, spreadsheet solvers, etc. In some examples, the model is a meta-model, and accepts hardware parameters of the provider node as input. Such models be provided one or more sets of parameters as inputs and be requested to produce another set of parameters as predicted values or outputs. Such models enable the compute estimator 850 to implement general parameter fits, not requiring that a parameter be only an input parameter or only an output parameter. The example compute estimator 850 provides the computed cost estimate as a response to the received request for the estimate. (Block 1230). The example process 1200 of FIG. 12 then terminates, but may be re-executed upon receipt of a subsequent request for a cost estimate.

FIG. 13 is a flowchart representative of example machine readable instructions 1300 that may be executed to implement the example provider node of FIGS. 7 and/or 8 to generate a meta model for use by other provider nodes. The example model trainer 865 generates a model for storage in the estimation model cache 860, and for subsequent use by the compute estimator 850. (Block 1310). In examples disclosed herein, the model used by the compute estimator 850 may be trained or developed asynchronously and/or offline. In some such examples, the model trainer 865 may be implemented at a node where there is sufficient computational assets to build and update such models.

As noted above, in some examples, the training performed by the model trainer 865 results in creation of a meta model. A meta model provides rules and/or estimations for translating from a model whose coefficients, weights, etc. are developed for one or more reference architecture setting and/or assets, to another architectural setting and/or assets. A meta model enables an edge node to access a trained model developed for a first node to be used by a second edge node having a different architecture. In this manner, the meta model is not trained for the second node, but is usable for creating estimations by the second node nonetheless. In some examples, parameters of the meta model include meta-estimators such as a meta-estimator for core scaling, cache scaling, etc., per trained estimator for each task. In this manner, the meta-estimators enable a reduction in the complexity of spanning every conceivable machine architecture (e.g., from a first processor architecture operating at a first frequency to a second processor architecture operating at a second frequency).

The example model synchronizer 870 provides the meta model stored in the estimation model cache 860 to another provider node. (Block 1320). In such examples, the model synchronizer 870 shares the models using pull, push, and/or publish-subscribe approaches. In some examples, the example instructions 1300 of FIG. 13 may be implemented at a data center node (e.g., a central node) to allow for creation of the model at a node having additional compute resources. In such an example, models may be trained on demand and then provided to requesting nodes.

FIG. 14 is a flowchart representative of example machine readable instructions 1400 that may be executed to implement the example provider node of FIGS. 7 and/or 8 to execute an operation requested by a consumer node. The example process 1400 of the illustrated example of FIG. 14 begins when the example network communicator 810 receives a request for execution of a compute operation. (Block 1410). The example network communicator 810 passes the request (and any data associated with the request) to the computation executor 880. The example computation executor obtains data for execution of the compute operation. (Block 1420). In some examples, the data to be used for execution of the compute operation is provided as a part of the request for execution of the compute operation. However, in some other examples, a reference to the data (e.g., a location in the data cache 830, a location at a remote data cache, a stream identifier, etc.) is used to enable the computation executor 880 to obtain the data for execution of the compute operation. The example computation executor, using the instructions stored in the instruction memory 840, executes the compute operation. (Block 1430). The example computation executor 880 then returns a result of the compute operation to the requesting node (e.g., the consumer node) via the network communicator 810. In some examples, the result is instead provided to another node (e.g., a second provider node) for performance of a subsequent computation operation. The example process 1400 of FIG. 14 then terminates, but may be re-executed upon, for example, receipt of a subsequent request for execution of a compute operation.

In the simplified example depicted in FIG. 15 is a block diagram of an example implementation of, an example edge compute node 1500 that includes a compute engine (also referred to herein as “compute circuitry”) 1502, an input/output (I/O) subsystem 1508, data storage 1510, a communication circuitry subsystem 1512, and, optionally, one or more peripheral devices 1514. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component. The example edge compute node 1500 of FIG. 15 may be deployed in one of the edge computing systems illustrated in FIGS. 1-4, 6, 7, and/or 8 to implement any edge compute node of FIGS. 1-4, 6, 7, and/or 8.

The compute node 1500 may be embodied as any type of engine, device, or collection of devices capable of performing various compute functions. In some examples, the compute node 1500 may be embodied as a single device such as an integrated circuit, an embedded system, a field-programmable gate array (FPGA), a system-on-a-chip (SOC), or other integrated system or device. In the illustrative example, the compute node 1500 includes or is embodied as a processor 1504 and a memory 1506. The processor 1504 may be embodied as any type of processor capable of performing the functions described herein (e.g., executing an application). For example, the processor 1504 may be embodied as a multi-core processor(s), a microcontroller, a processing unit, a specialized or special purpose processing unit, or other processor or processing/controlling circuit.

In some examples, the processor 1504 may be embodied as, include, or be coupled to an FPGA, an application specific integrated circuit (ASIC), reconfigurable hardware or hardware circuitry, or other specialized hardware to facilitate performance of the functions described herein. Also in some examples, the processor 1504 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC), acceleration circuitry, storage devices, or AI hardware (e.g., GPUs or programmed FPGAs). Such an xPU may be designed to receive programming to process one or more data streams and perform specific tasks and actions for the data streams (such as hosting microservices, performing service management or orchestration, organizing or managing server or data center hardware, managing service meshes, or collecting and distributing telemetry), outside of the CPU or general purpose processing hardware. However, it will be understood that a xPU, a SOC, a CPU, and other variations of the processor 1504 may work in coordination with each other to execute many types of operations and instructions within and on behalf of the compute node 1500.

The memory 1506 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In an example, the memory device is a block addressable memory device, such as those based on NAND or NOR technologies. A memory device may also include a three dimensional crosspoint memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may comprise a transistor-less stackable cross point architecture in which memory cells sit at the intersection of word lines and bit lines and are individually addressable and in which bit storage is based on a change in bulk resistance. In some examples, all or a portion of the memory 1506 may be integrated into the processor 1504. The memory 1506 may store various software and data used during operation such as one or more applications, data operated on by the application(s), libraries, and drivers.

The compute circuitry 1502 is communicatively coupled to other components of the compute node 1500 via the I/O subsystem 1508, which may be embodied as circuitry and/or components to facilitate input/output operations with the compute circuitry 1502 (e.g., with the processor 1504 and/or the main memory 1506) and other components of the compute circuitry 1502. For example, the I/O subsystem 1508 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 1508 may form a portion of a system-on-a-chip (SoC) and be incorporated, along with one or more of the processor 1504, the memory 1506, and other components of the compute circuitry 1502, into the compute circuitry 1502.

The one or more illustrative data storage devices 1510 may be embodied as any type of devices configured for short-term or long-term storage of data such as, for example, memory devices and circuits, memory cards, hard disk drives, solid-state drives, or other data storage devices. Individual data storage devices 1510 may include a system partition that stores data and firmware code for the data storage device 1510. Individual data storage devices 1510 may also include one or more operating system partitions that store data files and executables for operating systems depending on, for example, the type of compute node 1500.

The communication circuitry 1512 may be embodied as any communication circuit, device, or collection thereof, capable of enabling communications over a network between the compute circuitry 1502 and another compute device (e.g., an edge gateway of an implementing edge computing system). The communication circuitry 1512 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, a IoT protocol such as IEEE 802.15.4 or ZigBee®, low-power wide-area network (LPWAN) or low-power wide-area (LPWA) protocols, etc.) to effect such communication.

The illustrative communication circuitry 1512 includes a network interface controller (NIC) 1520, which may also be referred to as a host fabric interface (HFI). The NIC 1520 may be embodied as one or more add-in-boards, daughter cards, network interface cards, controller chips, chipsets, or other devices that may be used by the compute node 1500 to connect with another compute device (e.g., an edge gateway node). In some examples, the NIC 1520 may be embodied as part of a system-on-a-chip (SoC) that includes one or more processors, or included on a multichip package that also contains one or more processors. In some examples, the NIC 1520 may include a local processor (not shown) and/or a local memory (not shown) that are both local to the NIC 1520. In such examples, the local processor of the NIC 1520 may be capable of performing one or more of the functions of the compute circuitry 1502 described herein. Additionally, or alternatively, in such examples, the local memory of the NIC 1520 may be integrated into one or more components of the client compute node at the board level, socket level, chip level, and/or other levels.

Additionally, in some examples, a respective compute node 1500 may include one or more peripheral devices 1514. Such peripheral devices 1514 may include any type of peripheral device found in a compute device or server such as audio input devices, a display, other input/output devices, interface devices, and/or other peripheral devices, depending on the particular type of the compute node 1500. In further examples, the compute node 1500 may be embodied by a respective edge compute node (whether a client, gateway, or aggregation node) in an edge computing system or like forms of appliances, computers, subsystems, circuitry, or other components.

In a more detailed example, FIG. 16 illustrates a block diagram of an example may edge computing node 1650 structured to execute the instructions of FIGS. 11, 12, 13, and/or 14 to implement the techniques (e.g., operations, processes, methods, and methodologies) described herein such as the provider node 710 of FIGS. 7 and/or 8. This edge computing node 1650 provides a closer view of the respective components of node 1500 when implemented as or as part of a computing device (e.g., as a mobile device, a base station, server, gateway, etc.). The edge computing node 1650 may include any combinations of the hardware or logical components referenced herein, and it may include or couple with any device usable with an edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the edge computing node 1650, or as components otherwise incorporated within a chassis of a larger system. For example, the edge computing node 1650 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, an Internet of Things (IoT) device, or any other type of computing device.

The edge computing device 1650 may include processing circuitry in the form of a processor 1652, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 1652 may be a part of a system on a chip (SoC) in which the processor 1652 and other components are formed into a single integrated circuit, or a single package, such as the Edison™ or Galileo™ SoC boards from Intel Corporation, Santa Clara, Calif. As an example, the processor 1652 may include an Intel® Architecture Core™ based CPU processor, such as a Quark™, an Atom™, an i3, an i5, an i7, an i9, or an MCU-class processor, or another such processor available from Intel®. However, any number other processors may be used, such as available from Advanced Micro Devices, Inc. (AMD®) of Sunnyvale, Calif., a MIPS®-based design from MIPS Technologies, Inc. of Sunnyvale, Calif., an ARM®-based design licensed from ARM Holdings, Ltd. or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc. The processor 1652 and accompanying circuitry may be provided in a single socket form factor, multiple socket form factor, or a variety of other formats, including in limited hardware configurations or configurations that include fewer than all elements shown in FIG. 16. In this example, the processor implements the example network communicator 810, the example digest provider 820, the example compute estimator 850, the example model trainer 865, the example model synchronizer 870, and/or the example computation executor 880.

The processor 1652 may communicate with a system memory 1654 over an interconnect 1656 (e.g., a bus). Any number of memory devices may be used to provide for a given amount of system memory. As examples, the memory 1654 may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or

To provide for persistent storage of information such as data, applications, operating systems and so forth, a storage 1658 may also couple to the processor 1652 via the interconnect 1656. In an example, the storage 1658 may be implemented via a solid-state disk drive (SSDD). Other devices that may be used for the storage 1658 include flash memory cards, such as Secure Digital (SD) cards, microSD cards, eXtreme Digital (XD) picture cards, and the like, and Universal Serial Bus (USB) flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 1658 may be on-die memory or registers associated with the processor 1652. However, in some examples, the storage 1658 may be implemented using a micro hard disk drive (HDD). Further, any number of new technologies may be used for the storage 1658 in addition to, or instead of, the technologies described, such resistance change memories, phase change memories, holographic memories, or chemical memories, among others.

The components may communicate over the interconnect 1656. The interconnect 1656 may include any number of technologies, including industry standard architecture (ISA), extended ISA (EISA), peripheral component interconnect (PCI), peripheral component interconnect extended (PCIx), PCI express (PCIe), or any number of other technologies. The interconnect 1656 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 1656 may couple the processor 1652 to a transceiver 1666, for communications with the connected edge devices 1662. The transceiver 1666 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 1662. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 1666 (or multiple transceivers) may communicate using multiple standards or radios for communications at a different range. For example, the edge computing node 1650 may communicate with close devices, e.g., within about 10 meters, using a local transceiver based on Bluetooth Low Energy (BLE), or another low power radio, to save power. More distant connected edge devices 1662, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 1666 (e.g., a radio transceiver) may be included to communicate with devices or services in the edge cloud 1695 via local or wide area network protocols. The wireless network transceiver 1666 may be a low-power wide-area (LPWA) transceiver that follows the IEEE 802.15.4, or IEEE 802.15.4g standards, among others. The edge computing node 1650 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 1666, as described herein. For example, the transceiver 1666 may include a cellular transceiver that uses spread spectrum (SPA/SAS) communications for implementing high-speed communications. Further, any number of other protocols may be used, such as Wi-Fi® networks for medium speed communications and provision of network communications. The transceiver 1666 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 1668 may be included to provide a wired communication to nodes of the edge cloud 1695 or to other devices, such as the connected edge devices 1662 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 1668 may be included to enable connecting to a second network, for example, a first NIC 1668 providing communications to the cloud over Ethernet, and a second NIC 1668 providing communications to other devices over another type of network.

Given the variety of types of applicable communications from the device to another component or network, applicable communications circuitry used by the device may include or be embodied by any one or more of components 1664, 1666, 1668, or 1670. Accordingly, in various examples, applicable means for communicating (e.g., receiving, transmitting, etc.) may be embodied by such communications circuitry.

The edge computing node 1650 may include or be coupled to acceleration circuitry 1664, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific edge computing tasks for service management and service operations discussed elsewhere in this document.

The interconnect 1656 may couple the processor 1652 to a sensor hub or external interface 1670 that is used to connect additional devices or subsystems. The devices may include sensors 1672, such as accelerometers, level sensors, flow sensors, optical light sensors, camera sensors, temperature sensors, global navigation system (e.g., GPS) sensors, pressure sensors, barometric pressure sensors, and the like. The hub or interface 1670 further may be used to connect the edge computing node 1650 to actuators 1674, such as power switches, valve actuators, an audible sound generator, a visual warning device, and the like.

In some optional examples, various input/output (I/O) devices may be present within or connected to, the edge computing node 1650. For example, a display or other output device 1684 may be included to show information, such as sensor readings or actuator position. An input device 1686, such as a touch screen or keypad may be included to accept input. An output device 1684 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the edge computing node 1650. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 1676 may power the edge computing node 1650, although, in examples in which the edge computing node 1650 is mounted in a fixed location, it may have a power supply coupled to an electrical grid, or the battery may be used as a backup or for temporary capabilities. The battery 1676 may be a lithium ion battery, or a metal-air battery, such as a zinc-air battery, an aluminum-air battery, a lithium-air battery, and the like.

A battery monitor/charger 1678 may be included in the edge computing node 1650 to track the state of charge (SoCh) of the battery 1676, if included. The battery monitor/charger 1678 may be used to monitor other parameters of the battery 1676 to provide failure predictions, such as the state of health (SoH) and the state of function (SoF) of the battery 1676. The battery monitor/charger 1678 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 1678 may communicate the information on the battery 1676 to the processor 1652 over the interconnect 1656. The battery monitor/charger 1678 may also include an analog-to-digital (ADC) converter that enables the processor 1652 to directly monitor the voltage of the battery 1676 or the current flow from the battery 1676. The battery parameters may be used to determine actions that the edge computing node 1650 may perform, such as transmission frequency, mesh network operation, sensing frequency, and the like.

A power block 1680, or other power supply coupled to a grid, may be coupled with the battery monitor/charger 1678 to charge the battery 1676. In some examples, the power block 1680 may be replaced with a wireless power receiver to obtain the power wirelessly, for example, through a loop antenna in the edge computing node 1650. A wireless battery charging circuit, such as an LTC4020 chip from Linear Technologies of Milpitas, Calif., among others, may be included in the battery monitor/charger 1678. The specific charging circuits may be selected based on the size of the battery 1676, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 1658 may include instructions 1682 in the form of software, firmware, or hardware commands to implement the techniques described herein. Although such instructions 1682 are shown as code blocks included in the memory 1654 and the storage 1658, it may be understood that any of the code blocks may be replaced with hardwired circuits, for example, built into an application specific integrated circuit (ASIC).

In an example, the instructions 1682 provided via the memory 1654, the storage 1658, or the processor 1652 may be embodied as a non-transitory, machine-readable medium 1660 including code to direct the processor 1652 to perform electronic operations in the edge computing node 1650. The processor 1652 may access the non-transitory, machine-readable medium 1660 over the interconnect 1656. For instance, the non-transitory, machine-readable medium 1660 may be embodied by devices described for the storage 1658 or may include specific storage units such as optical disks, flash drives, or any number of other hardware devices. The non-transitory, machine-readable medium 1660 may include instructions to direct the processor 1652 to perform a specific sequence or flow of actions, for example, as described with respect to the flowchart(s) and block diagram(s) of operations and functionality depicted above. As used herein, the terms “machine-readable medium” and “computer-readable medium” are interchangeable.

Also in a specific example, the instructions 1682 on the processor 1652 (separately, or in combination with the instructions 1682 of the machine readable medium 1660) may configure execution or operation of a trusted execution environment (TEE) 1690. In an example, the TEE 1690 operates as a protected area accessible to the processor 1652 for secure execution of instructions and secure access to data. Various implementations of the TEE 1690, and an accompanying secure area in the processor 1652 or the memory 1654 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 1650 through the TEE 1690 and the processor 1652.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., Hypertext Transfer Protocol (HTTP)).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

The machine executable instructions of FIGS. 11, 12, 13, and/or 14 may be stored in the machine readable medium 1660 and/or on a removable non-transitory computer readable storage medium such as a CD or DVD.

In a more detailed example, FIG. 17 illustrates a block diagram of an example may edge computing node 1750 structured to execute the instructions 1000 of FIG. 10 to implement the techniques (e.g., operations, processes, methods, and methodologies) described herein such as the consumer node 720 of FIGS. 7 and/or 9. This edge computing node 1750 provides a closer view of the respective components of node 1500 when implemented as or as part of a computing device (e.g., as a mobile device, a base station, server, gateway, etc.). The edge computing node 1750 may include any combinations of the hardware or logical components referenced herein, and it may include or couple with any device usable with an edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the edge computing node 1750, or as components otherwise incorporated within a chassis of a larger system. For example, the edge computing node 1750 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, an Internet of Things (IoT) device, or any other type of computing device.

The edge computing device 1750 may include processing circuitry in the form of a processor 1752, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 1752 may be a part of a system on a chip (SoC) in which the processor 1752 and other components are formed into a single integrated circuit, or a single package, such as the Edison™ or Galileo™ SoC boards from Intel Corporation, Santa Clara, Calif. As an example, the processor 1752 may include an Intel® Architecture Core™ based CPU processor, such as a Quark™, an Atom™, an i3, an i5, an i7, an i9, or an MCU-class processor, or another such processor available from Intel®. However, any number other processors may be used, such as available from Advanced Micro Devices, Inc. (AMD®) of Sunnyvale, Calif., a MIPS®-based design from MIPS Technologies, Inc. of Sunnyvale, Calif., an ARM®-based design licensed from ARM Holdings, Ltd. or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc. The processor 1752 and accompanying circuitry may be provided in a single socket form factor, multiple socket form factor, or a variety of other formats, including in limited hardware configurations or configurations that include fewer than all elements shown in FIG. 17. In this example, the processor implements the example request accessor 910, the example cache digest interface 920, the example compute plan solver 940, the example privacy weighting circuitry, the example QoS controller 960, and/or the example plan executor 970.

The processor 1752 may communicate with a system memory 1754 over an interconnect 1756 (e.g., a bus). Any number of memory devices may be used to provide for a given amount of system memory. As examples, the memory 1754 may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 1758 may also couple to the processor 1752 via the interconnect 1756. In an example, the storage 1758 may be implemented via a solid-state disk drive (SSDD). Other devices that may be used for the storage 1758 include flash memory cards, such as Secure Digital (SD) cards, microSD cards, eXtreme Digital (XD) picture cards, and the like, and Universal Serial Bus (USB) flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 1758 may be on-die memory or registers associated with the processor 1752. However, in some examples, the storage 1758 may be implemented using a micro hard disk drive (HDD). Further, any number of new technologies may be used for the storage 1758 in addition to, or instead of, the technologies described, such resistance change memories, phase change memories, holographic memories, or chemical memories, among others.

The components may communicate over the interconnect 1756. The interconnect 1756 may include any number of technologies, including industry standard architecture (ISA), extended ISA (EISA), peripheral component interconnect (PCI), peripheral component interconnect extended (PCIx), PCI express (PCIe), or any number of other technologies. The interconnect 1756 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 1756 may couple the processor 1752 to a transceiver 1766, for communications with the connected edge devices 1762. The transceiver 1766 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 1762. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 1766 (or multiple transceivers) may communicate using multiple standards or radios for communications at a different range. For example, the edge computing node 1750 may communicate with close devices, e.g., within about 10 meters, using a local transceiver based on Bluetooth Low Energy (BLE), or another low power radio, to save power. More distant connected edge devices 1762, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 1766 (e.g., a radio transceiver) may be included to communicate with devices or services in the edge cloud 1795 via local or wide area network protocols. The wireless network transceiver 1766 may be a low-power wide-area (LPWA) transceiver that follows the IEEE 802.15.4, or IEEE 802.15.4g standards, among others. The edge computing node 1750 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 1766, as described herein. For example, the transceiver 1766 may include a cellular transceiver that uses spread spectrum (SPA/SAS) communications for implementing high-speed communications. Further, any number of other protocols may be used, such as Wi-Fi® networks for medium speed communications and provision of network communications. The transceiver 1766 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 1768 may be included to provide a wired communication to nodes of the edge cloud 1795 or to other devices, such as the connected edge devices 1762 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 1768 may be included to enable connecting to a second network, for example, a first NIC 1768 providing communications to the cloud over Ethernet, and a second NIC 1768 providing communications to other devices over another type of network.

Given the variety of types of applicable communications from the device to another component or network, applicable communications circuitry used by the device may include or be embodied by any one or more of components 1764, 1766, 1768, or 1770. Accordingly, in various examples, applicable means for communicating (e.g., receiving, transmitting, etc.) may be embodied by such communications circuitry.

The edge computing node 1750 may include or be coupled to acceleration circuitry 1764, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific edge computing tasks for service management and service operations discussed elsewhere in this document.

The interconnect 1756 may couple the processor 1752 to a sensor hub or external interface 1770 that is used to connect additional devices or subsystems. The devices may include sensors 1772, such as accelerometers, level sensors, flow sensors, optical light sensors, camera sensors, temperature sensors, global navigation system (e.g., GPS) sensors, pressure sensors, barometric pressure sensors, and the like. The hub or interface 1770 further may be used to connect the edge computing node 1750 to actuators 1774, such as power switches, valve actuators, an audible sound generator, a visual warning device, and the like.

In some optional examples, various input/output (I/O) devices may be present within or connected to, the edge computing node 1750. For example, a display or other output device 1784 may be included to show information, such as sensor readings or actuator position. An input device 1786, such as a touch screen or keypad may be included to accept input. An output device 1784 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the edge computing node 1750. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 1776 may power the edge computing node 1750, although, in examples in which the edge computing node 1750 is mounted in a fixed location, it may have a power supply coupled to an electrical grid, or the battery may be used as a backup or for temporary capabilities. The battery 1776 may be a lithium ion battery, or a metal-air battery, such as a zinc-air battery, an aluminum-air battery, a lithium-air battery, and the like.

A battery monitor/charger 1778 may be included in the edge computing node 1750 to track the state of charge (SoCh) of the battery 1776, if included. The battery monitor/charger 1778 may be used to monitor other parameters of the battery 1776 to provide failure predictions, such as the state of health (SoH) and the state of function (SoF) of the battery 1776. The battery monitor/charger 1778 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 1778 may communicate the information on the battery 1776 to the processor 1752 over the interconnect 1756. The battery monitor/charger 1778 may also include an analog-to-digital (ADC) converter that enables the processor 1752 to directly monitor the voltage of the battery 1776 or the current flow from the battery 1776. The battery parameters may be used to determine actions that the edge computing node 1750 may perform, such as transmission frequency, mesh network operation, sensing frequency, and the like.

A power block 1780, or other power supply coupled to a grid, may be coupled with the battery monitor/charger 1778 to charge the battery 1776. In some examples, the power block 1780 may be replaced with a wireless power receiver to obtain the power wirelessly, for example, through a loop antenna in the edge computing node 1750. A wireless battery charging circuit, such as an LTC4020 chip from Linear Technologies of Milpitas, Calif., among others, may be included in the battery monitor/charger 1778. The specific charging circuits may be selected based on the size of the battery 1776, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 1758 may include instructions 1782 in the form of software, firmware, or hardware commands to implement the techniques described herein. Although such instructions 1782 are shown as code blocks included in the memory 1754 and the storage 1758, it may be understood that any of the code blocks may be replaced with hardwired circuits, for example, built into an application specific integrated circuit (ASIC).

In an example, the instructions 1782 provided via the memory 1754, the storage 1758, or the processor 1752 may be embodied as a non-transitory, machine-readable medium 1760 including code to direct the processor 1752 to perform electronic operations in the edge computing node 1750. The processor 1752 may access the non-transitory, machine-readable medium 1760 over the interconnect 1756. For instance, the non-transitory, machine-readable medium 1760 may be embodied by devices described for the storage 1758 or may include specific storage units such as optical disks, flash drives, or any number of other hardware devices. The non-transitory, machine-readable medium 1760 may include instructions to direct the processor 1752 to perform a specific sequence or flow of actions, for example, as described with respect to the flowchart(s) and block diagram(s) of operations and functionality depicted above. As used herein, the terms “machine-readable medium” and “computer-readable medium” are interchangeable.

Also in a specific example, the instructions 1782 on the processor 1752 (separately, or in combination with the instructions 1782 of the machine readable medium 1760) may configure execution or operation of a trusted execution environment (TEE) 1790. In an example, the TEE 1790 operates as a protected area accessible to the processor 1752 for secure execution of instructions and secure access to data. Various implementations of the TEE 1790, and an accompanying secure area in the processor 1752 or the memory 1754 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 1750 through the TEE 1790 and the processor 1752.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., Hypertext Transfer Protocol (HTTP)).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

The machine executable instructions 1000 of FIG. 10 may be stored in the mass storage device 1782 and/or on a removable non-transitory computer readable storage medium such as a CD or DVD.

A block diagram illustrating an example software distribution platform 1805 to distribute software such as the example computer readable instructions 1682 of FIG. 16 and/or the example computer readable instructions 1782 of FIG. 17 to third parties is illustrated in FIG. 18. The example software distribution platform 1805 may be implemented by any computer server, data facility, cloud service, etc., capable of storing and transmitting software to other computing devices. The third parties may be customers of the entity owning and/or operating the software distribution platform. For example, the entity that owns and/or operates the software distribution platform may be a developer, a seller, and/or a licensor of software such as the example computer readable instructions 1682, 1782 of FIGS. 16 and/or 17. The third parties may be consumers, users, retailers, OEMs, etc., who purchase and/or license the software for use and/or re-sale and/or sub-licensing. In the illustrated example, the software distribution platform 1805 includes one or more servers and one or more storage devices. The storage devices store the computer readable instructions 1682, 1782, which may correspond to the example computer readable instructions 1682, 1782 of FIGS. 16 and/or 17, as described above. The one or more servers of the example software distribution platform 1805 are in communication with a network 1810, which may correspond to any one or more of the Internet and/or any of the example networks 1690, 1790 described above. In some examples, the one or more servers are responsive to requests to transmit the software to a requesting party as part of a commercial transaction. Payment for the delivery, sale and/or license of the software may be handled by the one or more servers of the software distribution platform and/or via a third party payment entity. The servers enable purchasers and/or licensors to download the computer readable instructions 1682, 1782 from the software distribution platform 1805. For example, the software, which may correspond to the example computer readable instructions 1682, 1782 of FIGS. 16 and/or 18, may be downloaded to the example processor platform 1650, 1750, which is to execute the computer readable instructions to implement the example provider node 710 and/or the example consumer node 720. In some example, one or more servers of the software distribution platform 1805 periodically offer, transmit, and/or force updates to the software (e.g., the example computer readable instructions 1682, 1782 of FIGS. 16 and/or 17) to ensure improvements, patches, updates, etc. are distributed and applied to the software at the end user devices.

From the foregoing, it will be appreciated that example methods, apparatus and articles of manufacture have been disclosed that enable movement of a location of execution of a computation among an edge cloud, as opposed to movement of data to such computation locations. Such examples enable edge nodes (and/or clusters of edge nodes) that best match in capabilities and cost before pushing computation to those edge nodes, based on data they may own or data that they may be caching. Such an approach enables improvement of distribution of computation over both stationary and streaming content. Further, use of meta-models enables scaling of models across a family of architectural parameters (e.g., processor architectures) and for transfer-learning in general as it applies to distributed computing. In some examples, the use of SmartNICs to perform data filtering and data reduction on behalf of computations that are shipped to them improves efficiency of the overall compute system by acting as a swarm of network-side proxies that collectively implement a map algorithm, a filtering operation (e.g., select), a data slicing operation (e.g., isolate subsets of data, such as column-groups or row-groups in data), a scanning operation, a tensor-multiply operation, etc. As a result, whether operations are performed in SmartNICs or in general purpose CPUs, compute operations may be pre-shipped to data and triggered on the basis of rules, execution plans, and security policies so that common types of distributed filtering operations can be applied just in time while data arrives at an edge node, instead of being performed later (e.g., on-demand) when data has already been aged out of local caches into colder storage. Additionally, the application of QoS techniques improves the overall computing efficiency of the compute system. The disclosed methods, apparatus and articles of manufacture improve the efficiency of using a computing device by selecting a location for execution of a computation that reduces computational and/or data transmission overhead. The disclosed methods, apparatus and articles of manufacture are accordingly directed to one or more improvement(s) in the functioning of a computer.

Example methods, apparatus, systems, and articles of manufacture to select a location of execution of a computation are disclosed herein. Further examples and combinations thereof include the following:

Example 1 includes an apparatus for selection of computation execution locations, the apparatus comprising a cache digest interface to identify a node capable of performing a computation, a compute plan solver to obtain a cost estimate of performing the computation from the node, privacy weighting circuitry to apply a privacy weighting value to the cost estimate to determine a weighted cost estimate, the compute plan solver to select the node for performance of the computation based on the weighted cost estimate, and a plan executor to transmit a request for the selected node to perform the computation.

Example 2 includes the apparatus of example 1, wherein the compute plan solver is to retrieve the cost estimate from a memory local to the apparatus.

Example 3 includes the apparatus of any one of examples 1 through 2, wherein the privacy weighting circuitry is to apply the privacy weighting value based on a privacy setting associated with data on which the computation is to be performed.

Example 4 includes the apparatus of any one of examples 1 through 3, wherein the privacy weighting circuitry is to apply the privacy weighting value based on a privacy setting associated with instructions for performing the computation.

Example 5 includes the apparatus of any one of examples 1 through 4, further including a quality of service controller to cause the plan executor to delay a threshold amount of time prior to transmitting the request to the provider node.

Example 6 includes the apparatus of any one of examples 1 through 5, wherein the node is executed at computing circuitry that is to implement the apparatus.

Example 7 includes the apparatus of any one of examples 1 through 6, wherein the provider node is to generate the cost estimate using a meta model, the meta model is to receive an identifier of a processor of the provider node as an input.

Example 8 includes at least one non-transitory computer readable medium comprising instructions that, when executed, cause at least one processor to at least identify a provider node capable of performing a computation, obtain a cost estimate of performing the computation from the provider node, apply a privacy weighting value to the cost estimate to determine a weighted cost estimate, select the provider node for performance of the computation based on the weighted cost estimate, and transmit a request for the provider node to perform the computation.

Example 9 includes the at least one non-transitory computer readable medium of example 8, wherein the instructions, when executed, cause the at least one processor to obtain the cost estimate by retrieving the cost estimate from a local memory of the processor.

Example 10 includes the at least one non-transitory computer readable medium of any one of examples 8 through 9, wherein the instructions, when executed, cause the at least one processor to apply the privacy weighting value based on a privacy setting associated with data on which the computation is to be performed.

Example 11 includes the at least one non-transitory computer readable medium of any one of examples 8 through 10, wherein the instructions, when executed, cause the at least one processor to apply the privacy weighting value based on a privacy setting associated with instructions for performing the computation.

Example 12 includes the at least one non-transitory computer readable medium of any one of examples 8 through 11, wherein the instructions, when executed, cause the at least one processor to delay a threshold amount of time prior to transmitting the request to the provider node, the delaying of the threshold amount of time to ensure a quality of service.

Example 13 includes the at least one non-transitory computer readable medium of any one of examples 8 through 12, wherein the provider node is executed by the at least one processor.

Example 14 includes the at least one non-transitory computer readable medium of any one of examples 8 through 13, wherein the provider node is to generate the cost estimate using a meta model, the meta model is to receive an identifier of a processor of the provider node as an input.

Example 15 includes a method for selecting computation execution locations, the method comprising identifying, by executing an instruction with a processor, a provider node capable of performing a computation, obtaining, by executing an instruction with the processor, a cost estimate of performing the computation from the provider node, applying, by executing an instruction with the processor, a privacy weighting value to the cost estimate to determine a weighted cost estimate, selecting, by executing an instruction with the processor, the provider node for performance of the computation based on the weighted cost estimate, and transmitting a request for the provider node to perform the computation.

Example 16 includes the method of example 15, wherein the obtaining of the cost estimate includes retrieving the cost estimate from a local memory of the processor.

Example 17 includes the method of any one of examples 15 through 16, wherein the application of the privacy weighting value is based on a privacy setting associated with data on which the computation is to be performed.

Example 18 includes the method of any one of examples 15 through 17, wherein the application of the privacy weighting value is based on a privacy setting associated with instructions for performing the computation.

Example 19 includes the method of any one of examples 15 through 18, further including delaying a threshold amount of time prior to transmitting the request to the provider node, the delaying of the threshold amount of time to ensure a quality of service.

Example 20 includes the method of any one of examples 15 through 19, wherein the provider node is executed by the processor.

Example 21 includes the method of any one of examples 15 through 20, wherein the provider node is to generate the cost estimate using a meta model, the meta model is to receive an identifier of a processor of the provider node as an input.

Example 22 includes an apparatus for selection of computation execution locations, the apparatus comprising means for identifying a provider node capable of performing a computation, means for solving to obtain a cost estimate of performing the computation from the provider node, means for weighting to apply a privacy weighting value to the cost estimate to determine a weighted cost estimate, the means for solving to select the provider node for performance of the computation based on the weighted cost estimate, and means for transmitting a request for the provider node to perform the computation.

Example 23 includes the apparatus of example 22, wherein the means for solving is to retrieve the cost estimate from a local memory.

Example 24 includes the apparatus of any one of examples 22 through 23, wherein the means for weighting is to apply the privacy weighting value based on a privacy setting associated with data on which the computation is to be performed.

Example 25 includes the apparatus of any one of examples 22 through 24, wherein the means for weighting is to apply the privacy weighting value based on a privacy setting associated with instructions for performing the computation.

Example 26 includes the apparatus of any one of examples 22 through 25, further including means for delaying to cause the means for transmitting to delay a threshold amount of time prior to transmitting the request to the provider node.

Example 27 includes the apparatus of any one of examples 22 through 26, wherein apparatus is to implement the provider node.

Example 28 is an edge computing gateway, comprising processing circuitry to perform any of Examples 1 through 27.

Example 29 is a base station, comprising a network interface card and processing circuitry to perform any of Examples 1 through 27.

Example 30 is a computer-readable medium comprising instructions to perform any of Examples 1 through 27.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

What is claimed is:

1. An apparatus for selection of computation execution locations, the apparatus comprising:
a cache digest interface to identify a node capable of performing a computation;
a compute plan solver to obtain a cost estimate of performing the computation from the node;
privacy weighting circuitry to apply a privacy weighting value to the cost estimate to determine a weighted cost estimate, the compute plan solver to select the node for performance of the computation based on the weighted cost estimate; and
a plan executor to transmit a request for the selected node to perform the computation.

2. The apparatus of claim 1, wherein the compute plan solver is to retrieve the cost estimate from a memory local to the apparatus.

3. The apparatus of claim 1, wherein the privacy weighting circuitry is to apply the privacy weighting value based on a privacy setting associated with data on which the computation is to be performed.

4. The apparatus of claim 1, wherein the privacy weighting circuitry is to apply the privacy weighting value based on a privacy setting associated with instructions for performing the computation.

5. The apparatus of claim 1, further including a quality of service controller to cause the plan executor to delay a threshold amount of time prior to transmitting the request to the provider node.

6. The apparatus of claim 1, wherein the node is executed at computing circuitry that is to implement the apparatus.

7. The apparatus of claim 1, wherein the provider node is to generate the cost estimate using a meta model, the meta model is to receive an identifier of a processor of the provider node as an input.

8. At least one non-transitory computer readable medium comprising instructions that, when executed, cause at least one processor to at least:
identify a provider node capable of performing a computation;
obtain a cost estimate of performing the computation from the provider node;
apply a privacy weighting value to the cost estimate to determine a weighted cost estimate;
select the provider node for performance of the computation based on the weighted cost estimate; and
transmit a request for the provider node to perform the computation.

9. The at least one non-transitory computer readable medium of claim 8, wherein the instructions, when executed, cause the at least one processor to obtain the cost estimate by retrieving the cost estimate from a local memory of the processor.

10. The at least one non-transitory computer readable medium of claim 8, wherein the instructions, when executed, cause the at least one processor to apply the privacy weighting value based on a privacy setting associated with data on which the computation is to be performed.

11. The at least one non-transitory computer readable medium of claim 8, wherein the instructions, when executed, cause the at least one processor to apply the privacy weighting value based on a privacy setting associated with instructions for performing the computation.

12. The at least one non-transitory computer readable medium of claim 8, wherein the instructions, when executed, cause the at least one processor to delay a threshold amount of time prior to transmitting the request to the provider node, the delaying of the threshold amount of time to ensure a quality of service.

13. The at least one non-transitory computer readable medium of claim 8, wherein the provider node is executed by the at least one processor.

14. The at least one non-transitory computer readable medium of claim 8, wherein the provider node is to generate the cost estimate using a meta model, the meta model is to receive an identifier of a processor of the provider node as an input.

15. A method for selecting computation execution locations, the method comprising:
identifying, by executing an instruction with a processor, a provider node capable of performing a computation;
obtaining, by executing an instruction with the processor, a cost estimate of performing the computation from the provider node;
applying, by executing an instruction with the processor, a privacy weighting value to the cost estimate to determine a weighted cost estimate;
selecting, by executing an instruction with the processor, the provider node for performance of the computation based on the weighted cost estimate; and
transmitting a request for the provider node to perform the computation.

16. The method of claim 15, wherein the obtaining of the cost estimate includes retrieving the cost estimate from a local memory of the processor.

17. The method of claim 15, wherein the application of the privacy weighting value is based on a privacy setting associated with data on which the computation is to be performed.

18. The method of claim 15, wherein the application of the privacy weighting value is based on a privacy setting associated with instructions for performing the computation.

19. The method of claim 15, further including delaying a threshold amount of time prior to transmitting the request to the provider node, the delaying of the threshold amount of time to ensure a quality of service.

20. The method of claim 15, wherein the provider node is executed by the processor.

21. The method of claim 15, wherein the provider node is to generate the cost estimate using a meta model, the meta model is to receive an identifier of a processor of the provider node as an input.

22. An apparatus for selection of computation execution locations, the apparatus comprising:
means for identifying a provider node capable of performing a computation;
means for solving to obtain a cost estimate of performing the computation from the provider node;
means for weighting to apply a privacy weighting value to the cost estimate to determine a weighted cost estimate, the means for solving to select the provider node for performance of the computation based on the weighted cost estimate; and
means for transmitting a request for the provider node to perform the computation.

23. The apparatus of claim 22, wherein the means for solving is to retrieve the cost estimate from a local memory.

24. The apparatus of claim 22, wherein the means for weighting is to apply the privacy weighting value based on a privacy setting associated with data on which the computation is to be performed.

25. The apparatus of claim 22, wherein the means for weighting is to apply the privacy weighting value based on a privacy setting associated with instructions for performing the computation.

26. (canceled)

27. (canceled)
